(19) United States
(12) Patent Application Publication
(10) Pub. No.: US 2015/0348558 A1
(43) Pub. Date: Dec. 3, 2015

(54) Audio Bitstreams with Supplementary Data and Encoding and Decoding of Such Bitstreams

(71) Applicant: Dolby Laboratories Licensing Corporation, San Francisco, CA (US)

(72) Inventors: Jeffrey Riedmiller, Penngrove, CA (US); Farhad Farahani, Los Altos, CA (US); Michael Hoffmann, Pacifica, CA (US); Michael Grant, San Francisco, CA (US); Freddie Sanchez, Berkeley, CA (US)

(21) Appl. No.: 14/822,168

(22) Filed: Aug. 10, 2015

Related U.S. Application Data
(63) Continuation of application No. PCT/US2014/015596, filed on Feb. 10, 2014.
Application No. PCT/US2014/015596 is a continuation-in-part of application No. 13/989,256, filed on May 23, 2013.
(60) Provisional application No. 61/889,131, filed on Oct. 10, 2013.
(60) Provisional application No. 61/763,254, filed on Feb. 11, 2013.
(60) Provisional application No. 61/419,747, filed on Dec. 3, 2010.
(60) Provisional application No. 61/558,286, filed on Nov. 10, 2011.

(51) Int. Cl. G10L 19/002

(52) U.S. Cl. CPC G10L 19/002

(57) ABSTRACT

Methods for generating or decoding an encoded audio bitstream including audio data and supplementary data (e.g., metadata and/or unrelated audio data), where at least some of the supplementary data is included as LSBs of audio segments, and/or at least some of the supplementary data is included in guard bands. Typical embodiments provide a scalable and video synchronous format compatible with real-time and file-based infrastructure components that support the SMPTE 337 format for carrying data in AES3 serial bitstreams, and/or provide a framework for extending distribution codecs to scale beyond an 8-channel limit to support multiples of 8 channels synchronously across multiple AES3 interfaces. Another aspect is an audio processing unit configured to perform any embodiment of the method or including a buffer memory storing at least one segment of an audio bitstream generated in accordance with any embodiment of the method.

### CROSS-REFERENCE TO RELATED APPLICATIONS

The present application is a continuation of, and claims the benefit of the filing date of the following pending PCT International Application which designates the United States: PCT International Application No. PCT/US2014/015596, filed Feb. 10, 2014 (International Filing Date), entitled “Audio Bitstreams with Supplementary Data and Encoding and Decoding of Such Bitstreams,” by Jeffrey Riedmiller, Farhad Farahani, Michael Hoffmann, Michael Grant, and Freddie Sanchez, which claims the benefit of the filing date of each of U.S. Provisional Patent Application No. 61/763,254, filed on Feb. 11, 2013 by Jeffrey Riedmiller and Farhad Farahani; U.S. patent application Ser. No. 13/989,256, filed on May 23, 2013 by Jeffrey Riedmiller, Regunathan Radhakrishnan, Marvin Pribadi, Farhad Farahani, and Michael Smithers; and U.S. Provisional Patent Application No. 61/889,131, filed on Oct. 10, 2013 by Jeffrey Riedmiller, Michael Hoffman, Farhad Farahani, Michael Grant, and Freddie Sanchez. PCT International Application No. PCT/US2014/015596 is a continuation-in-part of, and claims the benefit of the filing date of U.S. patent application Ser. No. 13/989,256. U.S. patent application Ser. No. 13/989,256 is a National Stage entry of PCT International Application No. PCT/US2011/062828, filed Dec. 1, 2011 (International Filing Date), entitled “Adaptive Processing with Multiple Media Processing Nodes,” by Jeffrey Riedmiller, Regunathan Radhakrishnan, Marvin Pribadi, Farhad Farahani, and Michael Smithers, which claims the benefit of the filing date of each of U.S. Provisional Patent Application No. 61/419,747, filed Dec. 3, 2010, entitled “End-to-End Metadata Preservation and Adaptive Processing,” by Jeffrey Riedmiller, Regunathan Radhakrishnan, Marvin Pribadi, Farhad Farahani, and Michael Smithers, and U.S. Provisional Patent Application No. 61/558,286, filed Nov. 10, 2011, entitled “Adaptive Processing with Multiple Media Processing Nodes,” by Jeffrey Riedmiller, Regunathan Radhakrishnan, Marvin Pribadi, Farhad Farahani, and Michael Smithers. The present application also claims the benefit of the filing date of each of U.S. Provisional Patent Application No. 61/889,131, filed on Oct. 10, 2013, U.S. Provisional Patent Application No. 61/763,254, filed on Feb. 11, 2013, U.S. Provisional Patent Application No. 61/419,747, on filed Dec. 3, 2010, and U.S. Provisional Patent Application No. 61/558,286, filed Nov. 10, 2011.

### TECHNICAL FIELD

The invention pertains to audio signal processing, and more particularly, to encoding and decoding of audio data bitstreams with primary audio data and supplementary data (e.g., metadata indicative of the processing state of the primary audio data, or additional audio content unrelated to the primary audio data). Some embodiments of the invention generate or decode an audio bitstream in the format known as Dolby E (or another AES3 bitstream), or two or more parallel AES3 bitstreams.

### BACKGROUND OF THE INVENTION

Dolby and Dolby E are trademarks of Dolby Laboratories Licensing Corporation.

A typical stream of audio data includes both audio content (e.g., one or more channels of audio content) and metadata indicative of at least one characteristic of the audio content. For example, in a conventional AC-3 or E-AC-3 bitstream there are several audio metadata parameters that are specifically intended for use in changing the sound of the program delivered to a listening environment. One of the metadata parameters is the DIALNORM parameter, which is intended to indicate the mean level of dialog occurring in an audio program, and is used to determine audio playback signal level. Dolby Laboratories provides proprietary implementations of AC-3 and E-AC-3 known as Dolby Digital and Dolby Digital Plus, respectively.

PCT International Application No. PCT/US2011/062828 (having Publication Number WO 2012/075246 A2, and an international filing date Dec. 1, 2011, and assigned to the assignee of the present application) discloses methods and systems for generating, decoding, and processing audio bitstreams including metadata indicative of the processing state (e.g., the loudness processing state) and characteristics (e.g., loudness) of audio content. It also describes adaptive processing of the audio content of the bitstreams using the metadata, and verification of validity of the loudness processing state and loudness of audio content of the bitstreams using the metadata. However, the reference does not describe inclusion in an audio bitstream of supplementary data (e.g., processing state metadata indicative of the processing state of primary audio content of the bitstream, or other metadata indicative of a characteristic of primary audio content of the bitstream, or additional audio content unrelated to primary audio content of the bitstream) in the manner (or in a format of a type) described in the present disclosure.

Although the present invention is not limited to use with an AES3 bitstream (e.g., a Dolby E bitstream), for convenience it will be described in embodiments in which it generates, decodes, or otherwise processes such a bitstream which includes supplementary data (e.g., processing state metadata).

AES3 (sometimes referred to as AES3/EBU) is an existing real-time transmission protocol for carrying audio information, described in the IEC 60958 standard. It is capable of transmitting a stereo digital audio signal (for example, 2 channels of 24-bit PCM audio sampled at 48 kHz). It is also capable of transmitting frames of compressed audio data in bursts (provided that the data rate of the compressed data does not exceed the channel transmission capacity (i.e., 2*48000*24 bit per second).

A known application of carrying bursts of compressed audio data in accordance with the AES3 protocol (i.e., in an AES3 bitstream) is the Dolby E audio coding system. Details of Dolby E coding are set forth in “Efficient Bit Allocation, Quantization, and Coding in an Audio Distribution System”, AES Preprint 5068, 107th AES Conference, August 1999 and “Professional Audio Coder Optimized for Use with Video”, AES Preprint 5033, 107th AES Conference August 1999.

Each burst (sometimes referred to herein as a “Dolby E burst” or “Dolby E frame”) of audio carried using Dolby E has SMPTE 337 format, and occupies a time period equivalent to that of a corresponding video frame (for example 1/30 s). The SMPTE 337 standard specifies a format for carrying non-pcm (non-pulse code modulated) data (including audio data) in an AES3 serial digital audio bitstream.

A Dolby E frame (burst) consists of a sequence of data structures having the format of AES3 frames. Each AES3 frame has a preamble, and two 24-bit subframes (each of which can convey a sample, e.g., a 20-bit sample, of a different audio channel). Each Dolby E burst can include samples of up to 8 different audio channels, and includes auxiliary bits indicating to which channel each sample belongs.

In a sequence of Dolby E bursts (which can include many Dolby E bursts), each Dolby E burst has a leading preamble, and a guard band. The Dolby E bursts (and thus the preambles and guard bands) occur at the rate of one per video frame period, and each burst's preamble can be used during processing of a Dolby E bitstream to identify the start of the burst and to time align the burst with other audio and/or video content. Typically, each guard band comprises a sequence of at least S samples (e.g., “silent” samples which are not indicative of audible audio content) which are identifiable by a Dolby E decoder as guard band samples, where S is a large number (e.g., S may be equal or substantially equal to 80 for an NTSC video frame period, or S may be equal or substantially equal to 100 for a PAL video frame period).

At a video frame rate 30 frames per second, and assuming 2 channels at 48 kHz and 24 bits per sample, a Dolby E burst would have capability to transmit 76800 bits of compressed audio data per video frame period. However, considerably fewer audio bits per video frame are typically required, so that typically, many of the available bits (of each Dolby E burst) are unused. These unused bits are typically set to 0 and carry no useful information. In the case of Dolby E, the lower 4 bits (four least significant bits) per sample do not carry any compressed data (i.e., the compressed data is only carried in the 20 most significant bits of each sample). Furthermore, the last M samples of a frame of S samples typically do not carry any compressed audio data (where S depends on the frame rate of the compressed audio and the sample rate of the transmission channel, and M depends on the size of the compressed data frame).

Typical embodiments of the present invention provide scalable format for including supplementary data (e.g., metadata indicative of the processing state of audio content or other metadata) in a Dolby E bitstream, or in another AES3 bitstream, or two or more parallel AES3 bitstreams. These embodiments use bits which are conventionally unused in AES3 bitstreams (and do not conventionally carry useful information), to carry useful information (e.g., additional compressed audio data indicative of at least one additional audio signal and typically also associated metadata). For example, such conventionally unused bits can be used in accordance with an embodiment of the invention as additional compressed audio data indicative of at least one additional audio channel not carried in a conventional version of the inventive bitstream in which the bits are unused.

PCT International Application No. PCT/US00/21303 (having Publication Number WO 01/11609 A1, and assigned to the assignee of the present application), and corresponding U.S. Pat. No. 6,446,036 (issued Sep. 3, 2002) discloses sending a layered audio signal, in which the core (main) layer of the signal (which can include multiple channels) is sent in the 16 most significant bits of each of a number of AES3 subframes of an AES3 bitstream, and an additional (intermediate) layer of the signal, and metadata and protection bits regarding the intermediate layer, are sent in the next most significant 4 bits of each such AES3 subframe of the bitstream. A third (fine) layer of the audio signal, and metadata and protection bits regarding the fine layer, are sent in the 4 least significant bits of each such AES3 subframe of the bitstream. The combination of the intermediate layer and the core layer determines an augmented version of the core layer which has increased resolution, and the combination of both the intermediate and fine layers with the core layer determines a further augmented version of the core layer which has further increased resolution.

However, this reference does not suggest that the intermediate and/or fine layer include: metadata regarding the core layer; or additional audio data unrelated to the audio content of the core layer in the sense that it is not a resolution-augmenting layer of the audio content of the core layer (e.g., where the audio content of the core layer is a channel of a multi-channel audio program, additional audio data which is another channel of the multi-channel program), or metadata indicative of processing state of audio content of any of the core, intermediate, or fine layers); or additional audio data which is not a resolution-augmenting layer of the audio content of the core layer but which is an object based audio program (or an object channel of an object based audio program) and optionally also metadata for such an object based audio program.

Conventional channel-based audio encoders typically operate under the assumption that each audio program (that is output by an encoder) will be reproduced by an array of loudspeakers in predetermined positions relative to a listener. Each channel of the program is a speaker channel. This type of audio encoding is commonly referred to as channel-based audio encoding.

Another type of audio encoder (known as an object-based audio encoder) implements an alternative type of audio coding known as audio object coding (or object based coding and operates under the assumption that each audio program (that is output by the encoder) may be rendered for reproduction by any of a large number of different arrays of loudspeakers. Each audio program output by such an encoder is an object based audio program, and typically, each channel of such object based audio program is an object channel. In audio object coding, audio signals associated with distinct sound sources (audio objects) are input to the encoder as separate audio streams. Examples of audio objects include (but are not limited to) a dialog track, a single musical instrument, and a jet aircraft. Each audio object is associated with spatial parameters, which may include (but are not limited to) source position, source width, and source velocity and/or trajectory. The audio objects and associated parameters are encoded for distribution and storage. Final audio object mixing and rendering is performed at the receive end of the audio storage and/or distribution chain, as part of audio program playback. The step of audio object mixing and rendering is typically based on knowledge of actual positions of loudspeakers to be employed to reproduce the program.

Typically, during generation of an object based audio program, the content creator embeds the spatial intent of the mix (e.g., the trajectory of each audio object determined by each object channel of the program) by including metadata in the program. The metadata can be indicative of the position or trajectory of each audio object determined by each object channel of the program, and/or at least one of the size, velocity, type (e.g., dialog or music), and another characteristic of each such object.

During rendering of an object based audio program, each object channel can be rendered “at” a position (e.g., a time-varying position having a desired trajectory) by generating speaker feeds indicative of content of the channel and applying the speaker feeds to a set of loudspeakers (where the physical position of each of the loudspeakers may or may not coincide with the desired position at any instant of time). The speaker feeds for a set of loudspeakers may be indicative of content of multiple object channels (or a single object channel). The rendering system typically generates the speaker feeds to match the exact hardware configuration of a specific reproduction system (e.g., the speaker configuration of a home theater system, where the rendering system is also an element of the home theater system).

In some embodiments of the present invention, the supplementary data carried in the inventive bitstream is or includes an object based audio program and/or metadata for such a program.

### BRIEF DESCRIPTION OF THE INVENTION

In a first class of embodiments, the invention is a method for encoding audio data (“primary” audio data) to generate an encoded audio bitstream, such that the encoded audio bitstream is indicative of supplementary data as well as the primary audio data. The encoded bitstream comprises a sequence of frames, each of the frames having N audio segments, where N is a positive integer (e.g., N=2, in the case that each of the frames has the structure of an AES3 frame), each of the audio segments comprises M bits (e.g., M=24, in the case that each of the frames has the structure of an AES3 frame), and the method includes steps of including at least some of the supplementary data as the P least significant bits (e.g., P=4) of each of at least some of the audio segments, and including some of the primary audio data as the M-P most significant bits of said each of at least some of the audio segments.

In one preferred format, the encoded bitstream is a Dolby E bitstream, at least some of the supplementary data is included in the four least significant bits (LSBs) of each of the two AES3 subframes of each of at least some of the AES3 frames of the bitstream, and the primary audio data is included in the 20 most significant bits (MSBs) of each of the two AES3 subframes of each AES3 frame of the bitstream.

Examples of the supplementary data include: additional audio content unrelated to the primary audio data (e.g., additional channels of audio data, distinct from each channel of the primary audio data); metadata associated with the primary audio data (e.g., metadata indicative of at least one feature or characteristic of the primary audio data); synchronization words (e.g., sync words useful for time alignment of the supplementary data and primary audio data, e.g., with data of other bitstreams, and/or sync words useful for synchronizing the supplementary data and primary audio data with corresponding video frames); protection bits (e.g., for authentication and/or validation of the primary audio data and/or supplementary data); and (when the supplementary data includes additional audio content) metadata associated with the additional audio content (e.g., metadata indicative of at least one feature or characteristic of the additional audio content). In some embodiments, the supplementary data is or includes processing state metadata indicative of what type(s) of processing have already been performed on the primary audio data. In some embodiments, the supplementary data includes additional audio content, and metadata which is (or includes) processing state metadata indicative of what type(s) of processing have already been performed on the primary audio data and/or the additional audio content.

In some embodiments, the primary audio data comprises one or more audio channels (sometimes referred to herein as “main” audio channels or channels of “main” audio content), and the additional audio content comprises one or more additional audio channels (wherein none of the additional audio channels is one of the main audio channels). For example, in some embodiments, the additional audio content comprises at least one object channel and metadata indicative of at least one said object channel.

In some embodiments in the first class, the frames are organized in a sequence of bursts, each of the bursts has a guard band segment, each of the bursts corresponds to a time period equivalent to that of a corresponding video frame, and the method includes a step of including at least some of the supplementary data in at least one said guard band segment. For example, each guard band segment may consist of a sequence of segments (e.g., 100 segments), each of the first X segments (e.g., X=20) of each guard band may include supplementary data, and each of the remaining segments of said each guard band may include a guard band symbol (the guard band symbol is typically a zero or “silent” audio sample, so that the guard band segments that do not include supplementary data provide zero padding).

In one preferred format, the encoded bitstream is a Dolby E bitstream, and at least some of the supplementary data (e.g., core element(s), of the type described below, of the supplementary data) is included in the first X sample locations of the Dolby E guard band interval of each of at least some of the Dolby E bursts of the bitstream, at least some of the supplementary data is included in the four LSBs of each of the two AES3 subframes of each of at least some of the AES3 frames of at least one of the Dolby E bursts, and the primary audio data is included in the 20 most significant bits (MSBs) of each of the two AES3 subframes of each of at least some of the AES3 frames of at least some of the Dolby E bursts. Each guard band interval typically includes at least S sample locations, where S is greater (e.g., substantially greater) than X (for example, S may be equal to 80 or 100).

In a second class of embodiments, the invention is a method of encoding audio data (“primary” audio data) to generate an encoded audio bitstream, such that the encoded audio bitstream is indicative of supplementary data as well as the primary audio data, wherein the encoded bitstream comprises a sequence of frames, each of the frames having N audio segments, where N is a positive integer (e.g., N=2, in the case that each of the frames has the structure of an AES3 frame), the frames are organized in a sequence of bursts, each of the bursts includes a guard band segment and a number of the frames (typically, each of the bursts corresponds to a time period equivalent to that of a corresponding video frame), and the method includes steps of including at least some of the supplementary data in at least one said guard band segment, and including the primary audio data in the audio segments of the frames. The supplementary data can be or include any of the types mentioned with reference to the first class of embodiments.

In one preferred format, the encoded bitstream is a Dolby E bitstream, and at least some of the supplementary data of each burst (e.g., core element(s), of the type described below, of the supplementary data) is included in the first X sample locations of the Dolby E guard band interval of each of at least some of the Dolby E bursts of the bitstream. Each guard band interval typically includes at least S sample locations, where S is greater (e.g., substantially greater) than X (for example, S may be equal to 80 or 100, and X may be equal to 20).

Typical embodiments of the invention provide a scalable and video synchronous format that is compatible with existing real-time and file-based infrastructure components that support the SMPTE 337 format for carrying non-pcm (non-pulse code modulated) audio data in an AES3 serial digital audio bitstream.

In some embodiments, the inventive bitstream is an AES3 serial digital audio bitstream (AES3 bitstream) comprising a sequence of bursts, where each burst carries audio data (e.g., primary audio data) and supplementary data (e.g., metadata indicative of at least one feature or characteristic of primary audio data) in SMPTE 337 format and occupies a time period equivalent to that of a corresponding video frame. In some cases (e.g., the case that the bitstream is a Dolby E compliant bitstream), each burst (e.g., a Dolby E burst) has SMPTE 337 format and includes a sequence of frames, each of the frames has the structure of an AES3 frame, and the primary audio data and supplemental data in each of the frames is non-PCM (non-pulse-code modulated) data.

For example, a class of embodiments of the invention provides methods and a framework for extending distribution codecs (e.g., those compliant with Dolby E, or which support the SMPTE 337 format for carrying non-pcm audio and data in an AES3 serial digital audio bitstream) to scale beyond the current channel limit of 8 channels to support multiples of 8 channels synchronously across multiple AES3 interfaces. This is done by generating a set of N of the inventive AES3 bitstreams, where N is a positive integer (e.g., N=1, 2, or 6), and typically also transmitting the N bitstreams in parallel or storing them as a file. Each bitstream comprises a sequence of bursts, where each burst carries audio data (e.g., primary audio data) and the inventive supplementary data (e.g., metadata indicative of at least one feature or characteristic of primary audio data) in SMPTE 337 format, and each burst typically occupies a time period equivalent to that of a corresponding video frame. Typically, each bitstream is indicative of up to eight channels of non-PCM audio (and/or non-PCM supplementary) data. Typically, the supplementary data of one or more of the bitstreams includes metadata (e.g., protection bits) shared by all the bitstreams. The supplementary data of each of the bitstreams can include synchronization words which can be used to time align the supplementary data and audio data of all N of the bitstreams, and/or to synchronize the supplementary data and audio data with corresponding video frames. Alternatively, each of the bitstreams can include a preamble (or other data structure), which does not include inventive supplementary data, but which includes at least one synchronization word (e.g., the synchronization bits of the preamble of a conventional Dolby E burst) which can be used to time align the supplementary data and audio data of all N of the bitstreams, and/or to synchronize the supplementary data and audio data with corresponding video frames.

In other embodiments, the inventive bitstream is an AES3 serial digital audio bitstream (AES3 bitstream) which carries audio data and supplementary data in a sequence of frames, each of the frames has the structure of an AES3 frame, the frames are not organized as a sequence of bursts (e.g., bursts each corresponding to a time period equivalent to that of a corresponding video frame). The primary audio data and supplemental data in each of the frames is LPCM (linear pulse code modulated) or other PCM data.

For example, a class of embodiments does not rely on the use of an underlying distribution codec and instead provides a mechanism to carry N sets of supplementary data (e.g., audio object channel/speaker channel/metadata combinations) in a set of N bitstreams, where N is a positive integer (e.g., N=1, 2, or 8). Each of the bitstreams is an AES3 bitstream indicative of two channels of 20-bit LPCM (linear pulse code modulated) audio data. More specifically, each AES3 bitstream carries audio data and supplementary data in a sequence of frames, each of the frames has the structure of an AES3 frame (including two subframes, each containing a 20-bit LPCM audio sample). The supplementary data (typically including object/speaker channel metadata and protection bits) is LPCM data carried in each of the auxiliary bit fields of the frames (i.e., as the four least significant bits in each AES3 subframe of each frame). Typically, the supplementary data includes synchronization words which can be used to time align the supplementary data and audio data of all N of the bitstreams, and/or to synchronize the supplementary data and audio data with corresponding video frames. In cases in which the input LPCM samples (presented to the encoder) would occupy all 24 bits of each AES3 subframe (e.g., where each input sample is a 20-bit audio sample payload plus four auxiliary bits), the encoder may dither the input samples to 20-bit values, and then writing one of the dithered 20-bit values (with four bits of supplementary data) into each of at least some of the AES3 subframes of the bitstream in accordance with the invention. The decoder would reverse this process at the direction of a ‘dither’ flag carried in the supplementary data stream.

In typical embodiments, the inventive bitstream include compressed, non-PCM audio data (and supplemental data) or PCM (e.g., LPCM) audio data (and supplemental data), formatted as per a two-channel AES3 signal.

Typical embodiments of the invention are useful for enabling audio content (e.g., any combination of additional audio channels (BEDs), audio object channels, channels indicative of clustered objects, and associated metadata) to be distributed within professional workflows for broadcast and online markets.

Aspects of the invention defines methods and a framework for extending distribution codecs (e.g., those compliant with Dolby E, and/or which support the SMPTE 337 format for carrying non-pcm data in an AES3 serial digital audio bitstream) to scale beyond the conventional channel limit of 8 channels, to support multiples of 8 channels synchronously across multiple AES3 interfaces. In accordance with some embodiments of the invention, this is accomplished by generating (and storing or transmitting) at least two of the inventive bitstreams (e.g., generating at least two such bitstreams and transmitting them in parallel), each bitstream carrying up to 8 channels of audio data, and typically also including metadata (which may consist of or include protection bits). The bitstreams together determine up to M*8 channels of audio (where M is an integer greater than 2), and each of the bitstreams can be considered a substream of a combined bitstream indicative of all the audio data and metadata carried by all the bitstreams. The metadata carried by each bitstream may (but need not) include or consist of metadata indicative of all the bitstreams (i.e., shared by all the bitstreams). For example, each bitstream may include up to 8 channels of audio data, metadata (including protection bits) for these channels of audio data, and protection bits for data of at least one other one of the bitstreams.

Some embodiments of the invention (e.g., which generate and/or send and/or receive a single Dolby E compliant bitstream) are backward compatible with conventional decoders (e.g., a Dolby E decoder). Some embodiments of the invention (e.g., which generate and/or send and/or receive multiple AES3 bitstreams) are not backward compatible with a conventional decoder (e.g., a Dolby E decoder). For example, they may need to be configured in accordance with an embodiment of the present invention to use metadata (sent in one or more of a set of bitstreams) to synchronize all the bitstreams.

In typical embodiments, the inventive method includes a step of multiplexing primary audio data with supplementary data in each segment (e.g., burst) of a serial bitstream. In typical decoding, a decoder extracts the supplementary data from the bitstream (including by parsing and demultiplexing the supplementary data and the primary audio data), and processes the primary audio data to generate a stream of decoded audio data (and in some cases also performs at least one of adaptive processing (e.g., adaptive loudness processing) of the primary audio data, or authentication and/or validation of supplementary data and/or primary audio data using the supplementary data). In some cases, the decoded audio data and supplementary data are forwarded from the decoder to a post-processor configured to perform adaptive processing on the decoded audio data using the supplementary data. The adaptive processing can include or consist of dynamic range and/or loudness control (e.g., dialog loudness leveling or other volume leveling). In response to supplementary data which is or includes loudness state processing metadata (LPSM), an audio processing unit may disable loudness processing that has already been performed (as indicated by the LPSM) on corresponding audio content.

Supplementary data (e.g., metadata) embedded in an audio bitstream in accordance with typical embodiments of the invention may be authenticated and validated, e.g., to enable loudness regulatory entities to verify whether the loudness of the audio content of a particular program is already within a specified range and that the corresponding audio data itself have not been modified (thereby ensuring compliance with applicable regulations). For example, where the supplementary data is or includes loudness processing state metadata, a loudness value included in a data block comprising the loudness processing state metadata may be read out to verify this, instead of again computing the loudness of the audio content.

Another aspect of the invention is an audio processing unit (APU) configured to perform any embodiment of the inventive method. In another class of embodiments, the invention is an APU including a buffer memory (buffer) which stores (e.g., in a non-transitory manner) at least one segment (e.g., burst or frame) of an encoded audio bitstream which has been generated by any embodiment of the inventive method. Examples of APUs include, but are not limited to encoders (e.g., transcoders), decoders, codecs, pre-processing systems (pre-processors), post-processing systems (post-processors), audio bitstream processing systems, and combinations of such elements.

In some embodiments, supplementary data is provided in segments in the inventive bitstream, and each of the segments of the supplementary data has the following format:

a core header (typically including a syncword identifying the start of supplementary data of one type, followed by identification values, e.g., core element version, length, and period, extended element count, and substream association values); and

after the core header, at least one protection value (e.g., an HMAC digest and Audio Fingerprint values, where the HMAC digest may be a 256-bit HMAC digest (e.g., using SHA-2 algorithm) computed over primary audio data, and the core element and all expanded elements of supplementary data of the relevant type, of an entire burst) useful for at least one of decryption, authentication, or validation of at least one of supplementary data or corresponding audio data); and

also after the core header, if the supplementary data includes metadata, metadata payload identification (“ID”) and payload size values which identify following metadata as a payload of some indicated type and indicate size of the payload; and

also after the core header (e.g., after the payload ID and payload size values), a supplementary data payload (or container).

If more than one type of metadata is included in the supplementary data, such core header, protection value(s), and payload identification (“ID”) and payload size values are provided for each type of metadata, and are sometimes referred to herein as the “core element” of the metadata (of the relevant type).

In some embodiments of the type described in the two previous paragraphs, each of the segments of supplementary data in the bitstream has three levels of structure:

a high level structure, including a flag indicating whether a burst (e.g., the LSBs of AES3 subframes of the burst and/or a guard band of the burst) includes supplementary data, at least one ID value indicating what type(s) of supplementary data (e.g., metadata) are present, and typically also a value indicating how many bits of supplementary data (e.g., of each type) are present (if supplementary data is present). One type of supplementary data that could be present is processing state metadata (e.g., loudness processing state metadata), another type of metadata that could be present is indicative of at least one characteristic of an audio object, and another type of metadata that could be present is media rating metadata;

an intermediate level structure, comprising a core element for each identified type of supplementary data (e.g., core header, protection values, and payload ID and payload size values, e.g., of the type mentioned above, for each identified type of metadata or other identified type of supplementary data); and

a low level structure, comprising each payload for one core element (e.g., a processing state metadata payload, if one is identified by the core element as being present, and/or a metadata payload of another type, if one is identified by the core element as being present).

In some embodiments, the inventive bitstream comprises a sequence of frames (each having the structure of an AES3 frame) organized as a sequence of bursts (e.g., Dolby E bursts), each of the bursts has a guard band segment and corresponds to a time period equivalent to that of a corresponding video frame, and the supplementary data in each burst has the preferred format described in the three previous paragraphs regardless of whether the supplementary data are included in LSBs of subframes of the frames and/or in the burst's guard band. When the bitstream is decoded, the supplementary data in each burst are identified and parsed (e.g., into core elements and payloads) regardless of where the supplementary data bits temporally occur in the burst. In other embodiments, the inventive bitstream comprises a sequence of frames (each having the structure of an AES3 frame) not organized as a sequence of bursts, and the supplementary data in the bitstream is organized into structures each having the preferred format described in the three previous paragraphs regardless of where the supplementary data bits temporally occur in the bitstream. Decoding of the latter embodiments of the bitstream includes a step of parsing the supplementary data (e.g., into core elements and payloads) regardless of where the supplementary data bits temporally occur in the bitstream.

In another class of embodiments, the invention is an audio processing unit or “APU” (e.g., a decoder) coupled and configured to receive an encoded audio bitstream (which has been generated in accordance with an embodiment of the invention and comprises primary audio data and supplementary data), to extract the supplementary data (which is or includes LPSM and/or other processing state metadata) from the bitstream, to generate decoded audio data in response to the primary audio data and to perform at least one adaptive processing operation on the audio data using the processing state metadata. Some embodiments in this class also include a post-processor coupled to the APU, wherein the post-processor is coupled and configured to perform at least one adaptive processing operation on the audio data using the processing state metadata.

In another class of embodiments, the invention is an audio processing unit including a buffer memory (buffer) and a processing subsystem coupled to the buffer, wherein the audio processing unit (APU) is coupled to receive an encoded audio bitstream (which has been generated in accordance with an embodiment of the invention and comprises primary audio data and supplementary data), the buffer stores (e.g., in a non-transitory manner) at least one segment (e.g., burst or frame) of the encoded audio bitstream, and the processing subsystem is configured to extract the supplementary data (which is or includes LPSM and/or other processing state metadata) from the bitstream and to perform at least one adaptive loudness processing operation on the primary audio data using the processing state metadata. In typical embodiments in this class, the APU is one of an encoder, a decoder, and a post-processor.

It should be understood that in variations on all embodiments of the invention described herein with reference to generation and/or transmission of bitstreams, the audio data and supplemental data included in one or more such bitstreams can instead be included and stored in a file. For example, some aspects of the invention define methods for carriage of supplemental data (e.g., metadata) as well as audio data within broadcast and online contribution and distribution systems. Additionally, aspects of the invention define a new storage format for mezzanine encoded supplementary data (e.g., hybrid channel/object/metadata) and primary audio data, for professional file-based workflows. Typically, a “mezzanine” file is a clean, high bit rate, digital master created using a production codec.

Aspects of the invention include a system or device configured (e.g., programmed) to perform any embodiment of the inventive method, and a computer readable medium (e.g., a disc) which stores code (e.g., in a non-transitory manner) for implementing any embodiment of the inventive method or steps thereof, or data indicative of an encoded audio bitstream generated in accordance with any embodiment of the invention. For example, the inventive system can be or include a programmable general purpose processor, digital signal processor, or microprocessor, programmed with software or firmware and/or otherwise configured to perform any of a variety of operations on data, including an embodiment of the inventive method or steps thereof. Such a general purpose processor may be or include a computer system including an input device, a memory, and processing circuitry programmed (and/or otherwise configured) to perform an embodiment of the inventive method (or steps thereof) in response to data asserted thereto.

### BRIEF DESCRIPTION OF THE DRAWINGS

FIG. 1 is a block diagram of an embodiment of a system which may be configured to perform an embodiment of the inventive method.

FIG. 2 is a block diagram of an encoder which is an embodiment of the inventive audio processing unit.

FIG. 3 is a block diagram of a decoder which is an embodiment of the inventive audio processing unit, and a post-processor coupled thereto which is another embodiment of the inventive audio processing unit.

FIG. 4 is a diagram of a Dolby E bitstream generated in accordance with an embodiment of the invention, comprising a sequence of Dolby E bursts (sometimes referred to as Dolby E frames), each of the bursts including supplementary data.

FIG. 5 is a diagram of a segment of the FIG. 4 bitstream, which has the format of an AES3 frame.

FIG. 6 is a diagram of a set of N Dolby E bitstreams generated in accordance with an embodiment of the invention, each bitstream comprising a sequence of Dolby E bursts, and each of said bursts including supplementary data.

FIG. 7 is a block diagram of an embodiment of the inventive encoder.

FIG. 8 is a block diagram of an embodiment of the inventive decoder.

FIG. 9 is a diagram of a frame (burst) of a Dolby E bitstream generated in accordance with an embodiment of the invention. Each of the primary data segment, the extension data segment, and the guard band of the burst includes supplementary data (metadata).

### NOTATION AND NOMENCLATURE

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the expressions “audio processor” and “audio processing unit” are used interchangeably, and in a broad sense, to denote a system configured to process audio data. Examples of audio processing units include, but are not limited to encoders (e.g., transcoders), decoders, codecs, pre-processing systems, post-processing systems, and bitstream processing systems (sometimes referred to as bitstream processing tools).

Throughout this disclosure including in the claims, the expression “metadata” (e.g., as in the expression “processing state metadata”) refers to separate and different data from corresponding audio data (audio content of a bitstream which also includes metadata). Metadata is associated with audio data, and indicates at least one feature or characteristic of the audio data (e.g., what type(s) of processing have already been performed, or should be performed, on the audio data). The association of the metadata with the audio data is time-synchronous. Thus, present (most recently received or updated) metadata may indicate that the corresponding audio data contemporaneously has an indicated feature and/or comprises the results of an indicated type of audio data processing.

Throughout this disclosure including in the claims, the expression “processing state metadata” denotes metadata indicative of the processing state of corresponding audio data (e.g. what type(s) of processing have been performed on the audio data) and typically also at least one feature or characteristic (e.g., loudness) of the corresponding audio data. Processing state metadata may include data (e.g., other metadata) that is not (i.e., when it is considered alone) processing state metadata. In some cases, processing state metadata may include processing history and/or some or all of the parameters that are used in and/or derived from the indicated types of processing. Additionally, processing state metadata may include at least one feature or characteristic of the corresponding audio data, which has been computed or extracted from the audio data. Processing state metadata may also include other metadata that is not related to or derived from any processing of the corresponding audio data. For example, third party data, tracking information, identifiers, proprietary or standard information, user annotation data, user preference data, etc. may be added by a particular audio processing unit to pass on to other audio processing units.

Throughout this disclosure including in the claims, the expression “loudness processing state metadata” (or “LPSM”) denotes processing state metadata indicative of the loudness processing state of corresponding audio data (e.g. what type(s) of loudness processing have been performed on the audio data) and typically also at least one feature or characteristic (e.g., loudness) of the corresponding audio data. Loudness processing state metadata may include data (e.g., other metadata) that is not (i.e., when it is considered alone) loudness processing state metadata.

Throughout this disclosure including in the claims, the expression “supplementary data” (included with primary audio data in a bitstream) is used in a broad sense to denote any of: additional audio content unrelated to the primary audio data (in the sense that it is not merely a portion of the primary audio data, and is not merely an enhancement or augmentation layer for augmenting or enhancing the primary audio data, e.g., to increase its resolution); and/or metadata associated with (or unrelated to) the primary audio data or other supplementary data included in the bitstream or a related bitstream (e.g., metadata indicative of at least one feature or characteristic of the primary audio data, or protection bits for the primary audio data and/or for other supplementary data in the bitstream or a related bitstream); and/or (when the supplementary data includes additional audio content) metadata associated with (or unrelated to) the additional audio content (e.g., metadata indicative of at least one feature or characteristic of the additional audio content). Some examples of supplementary data in a bitstream are: processing state metadata indicative of what type(s) of processing have already been performed on corresponding primary audio data; and (where the bitstream includes at least one channel of primary audio data) additional audio content of at least one audio channel (e.g., an object channel) other than any channel of the primary audio data.

Throughout this disclosure including in the claims, the term “couples” or “coupled” is used to mean either a direct or indirect connection. Thus, if a first device couples to a second device, that connection may be through a direct connection, or through an indirect connection via other devices and connections.

Throughout this disclosure including in the claims, the following expressions have the following definitions:

channel (or “audio channel”): a monophonic audio signal;

speaker channel (or “speaker-feed channel”): an audio channel that is associated with a named loudspeaker (at a desired or nominal position), or with a named speaker zone within a defined speaker configuration. A speaker channel is rendered in such a way as to be equivalent to application of the audio signal directly to the named loudspeaker (at the desired or nominal position) or to a speaker in the named speaker zone;

object channel: an audio channel indicative of sound emitted by an audio source (sometimes referred to as an audio “object”). Typically, an object channel determines a parametric audio source description. The source description may determine sound emitted by the source (as a function of time), the apparent position (e.g., 3D spatial coordinates) of the source as a function of time, and optionally at least one additional parameter (e.g., apparent source size or width) characterizing the source;

audio program: a set of one or more audio channels (at least one speaker channel and/or at least one object channel) and optionally also associated metadata (e.g., metadata that describes a desired spatial audio presentation); and

object based audio program: an audio program comprising a set of one or more object channels (and optionally also comprising at least one speaker channel) and optionally also associated metadata that describes a desired spatial audio presentation (e.g., metadata indicative of a trajectory of an audio object which emits sound indicated by an object channel).

### DETAILED DESCRIPTION OF EMBODIMENTS OF THE INVENTION

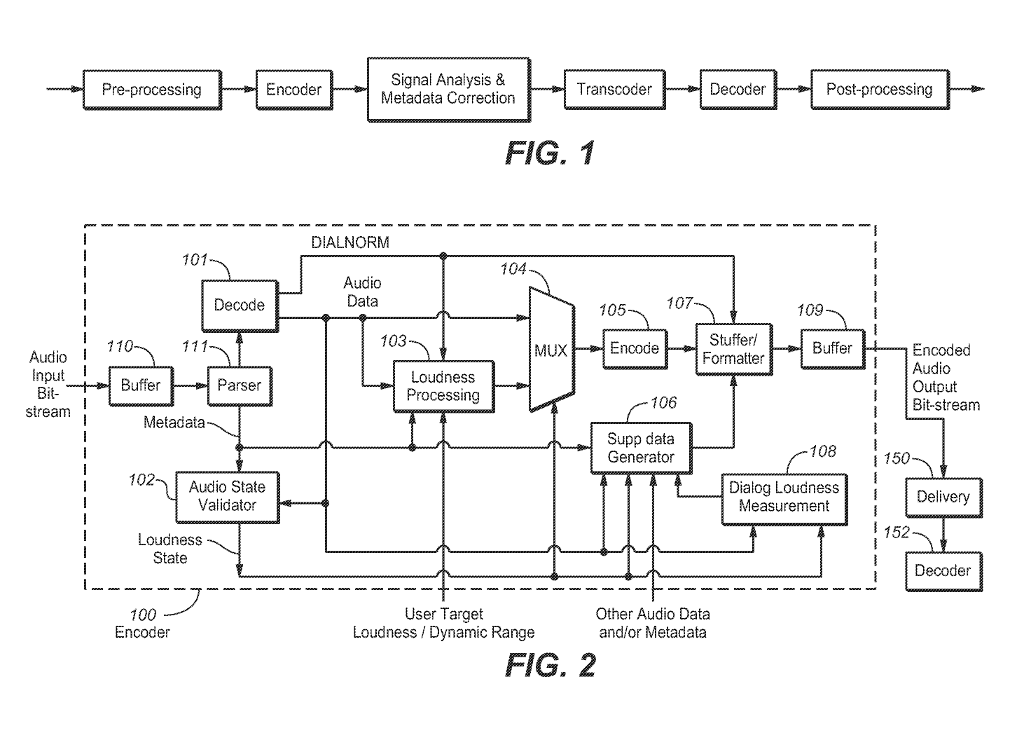

FIG. 1 is a block diagram of an exemplary audio processing chain (an audio data processing system), in which one or more of the elements of the system may be configured in accordance with an embodiment of the present invention. The system includes the followings elements, coupled together as shown: a pre-processing unit, an encoder, a signal analysis and metadata correction unit, a transcoder, a decoder, and a post-processing unit. In variations on the system shown, one or more of the elements are omitted, or additional audio data processing units are included.

In some implementations, the pre-processing unit of FIG. 1 is configured to accept PCM (time-domain) samples comprising audio content as input, and to output processed PCM samples. The encoder may be configured to accept the PCM samples as input and to output an encoded (e.g., compressed) audio bitstream indicative of the audio content. The data of the bitstream that are indicative of the audio content are sometimes referred to herein as “audio data.” If the encoder is configured in accordance with a typical embodiment of the present invention, the audio bitstream output from the encoder includes loudness processing state metadata (and typically also other metadata) as well as audio data.

The signal analysis and metadata correction unit of FIG. 1 may accept one or more encoded audio bitstreams as input and determine (e.g., validate) whether processing state metadata in each encoded audio bitstream is correct, by performing signal analysis. If the signal analysis and metadata correction unit finds that included metadata is invalid, it typically replaces the incorrect value(s) with the correct value(s) obtained from signal analysis. Thus, each encoded audio bitstream output from the signal analysis and metadata correction unit may include corrected (or uncorrected) processing state metadata as well as encoded audio data.

The transcoder of FIG. 1 may accept encoded audio bitstreams as input, and output modified (e.g., differently encoded) audio bitstreams in response (e.g., by decoding an input stream and re-encoding the decoded stream in a different encoding format). If the transcoder is configured in accordance with a typical embodiment of the present invention, the audio bitstream output from the transcoder includes loudness processing state metadata (and typically also other metadata) as well as encoded audio data. The metadata may have been included in the bitstream.

The decoder of FIG. 1 may accept encoded (e.g., compressed) audio bitstreams as input, and output (in response) streams of decoded PCM audio samples. If the decoder is configured in accordance with a typical embodiment of the present invention, the output of the decoder in typical operation is or includes any of the following:

a stream of audio samples, and a corresponding stream of loudness processing state metadata (and typically also other metadata) extracted from an input encoded bitstream; or

a stream of audio samples, and a corresponding stream of control bits determined from loudness processing state metadata (and typically also other metadata) extracted from an input encoded bitstream; or

a stream of audio samples, without a corresponding stream of processing state metadata or control bits determined from processing state metadata. In this last case, the decoder may extract loudness processing state metadata (and/or other metadata) from the input encoded bitstream and perform at least one operation on the extracted metadata (e.g., validation), even though it does not output the extracted metadata or control bits determined therefrom.

By configuring the post-processing unit of FIG. 1 in accordance with a typical embodiment of the present invention, the post-processing unit is configured to accept a stream of decoded PCM audio samples, and to perform post processing thereon (e.g., volume leveling of the audio content) using loudness processing state metadata (and typically also other metadata) received with the samples, or control bits (determined by the decoder from loudness processing state metadata and typically also other metadata) received with the samples. The post-processing unit is typically also configured to render the post-processed audio content for playback by one or more speakers.

Typical embodiments of the present invention provide an enhanced audio processing chain in which audio processing units (e.g., encoders, decoders, transcoders, and pre- and post-processing units) adapt their respective processing to be applied to audio data according to a contemporaneous state of the media data as indicated by loudness processing state metadata respectively received by the audio processing units.

The audio data input to any audio processing unit of the FIG. 1 system (e.g., the encoder or transcoder of FIG. 1) may include loudness processing state metadata (and optionally also other metadata) as well as audio data (e.g., encoded audio data). This metadata may have been included in the input audio by another element of the FIG. 1 system (or another source, not shown in FIG. 1) in accordance with an embodiment of the present invention. The processing unit which receives the input audio (with metadata) may be configured to perform at least one operation on the metadata (e.g., validation) or in response to the metadata (e.g., adaptive processing of the input audio), and typically also to include in its output audio the metadata, a processed version of the metadata, or control bits determined from the metadata.

A typical embodiment of the inventive audio processing unit (or audio processor) is configured to perform adaptive processing of audio data based on the state of the audio data as indicated by loudness processing state metadata corresponding to the audio data. In some embodiments, the adaptive processing is (or includes) loudness processing (if the metadata indicates that the loudness processing, or processing similar thereto, has not already been performed on the audio data), but is not (and does not include) loudness processing (if the metadata indicates that such loudness processing, or processing similar thereto, has already been performed on the audio data). In some embodiments, the adaptive processing is or includes metadata validation (e.g., performed in a metadata validation sub-unit) to ensure the audio processing unit performs other adaptive processing of the audio data based on the state of the audio data as indicated by the loudness processing state metadata. In some embodiments, the validation determines reliability of the loudness processing state metadata associated with (e.g., included in a bitstream with) the audio data. For example, if the metadata is validated to be reliable, then results from a type of previously performed audio processing may be re-used and new performance of the same type of audio processing may be avoided. On the other hand, if the metadata is found to have been tampered with (or otherwise unreliable), then the type of media processing purportedly previously performed (as indicated by the unreliable metadata) may be repeated by the audio processing unit, and/or other processing may be performed by the audio processing unit on the metadata and/or the audio data. The audio processing unit may also be configured to signal to other audio processing units downstream in an enhanced media processing chain that loudness processing state metadata (e.g., present in a media bitstream) is valid, if the unit determines that the processing state metadata is valid (e.g., based on a match of a cryptographic value extracted and a reference cryptographic value).

FIG. 2 is a block diagram of an encoder (100) which is an embodiment of the inventive audio processing unit. Any of the components or elements of encoder 100 may be implemented as one or more processes and/or one or more circuits (e.g., ASICs, FPGAs, or other integrated circuits), in hardware, software, or a combination of hardware and software. Encoder 100 comprises buffer 110, parser 111, decoder 101, audio state validator 102, loudness processing stage 103, audio stream selection stage 104, encoder 105, stuffer/formatter stage 107, supplementary data generation stage 106, dialog loudness measurement subsystem 108, and buffer 109, connected as shown. Typically also, encoder 100 includes other processing elements (not shown).

Encoder 100 (which is a transcoder) is configured to convert an input audio bitstream (which, for example, may be an AC-3 bitstream, or an E-AC-3 bitstream) to an encoded output audio bitstream (which, for example, may be a Dolby E bitstream) including by performing adaptive and automated loudness processing using loudness processing state metadata (LPSM) included in the input bitstream.

The system of FIG. 2 also includes encoded audio delivery subsystem 150 (which stores and/or delivers the encoded bitstreams output from encoder 100) and decoder 152. An encoded audio bitstream output from encoder 100 may be stored by subsystem 150 (e.g., in the form of a DVD or Blu ray disc), or transmitted by subsystem 150 (which may implement a transmission link or network), or may be both stored and transmitted by subsystem 150. Decoder 152 is configured to decode an encoded audio bitstream (generated by encoder 100) which it receives via subsystem 150, including by extracting supplementary data from each burst of the bitstream, and generating decoded audio data. Typically, decoder 152 is configured to perform adaptive loudness processing on the decoded audio data using the LPSM, and/or to forward the decoded audio data and LPSM to a post-processor configured to perform adaptive loudness processing on the decoded audio data using the LPSM. Typically, decoder 152 includes a buffer which stores (e.g., in a non-transitory manner) the encoded audio bitstream received from subsystem 150.

Various implementations of encoder 100 and decoder 152 are configured to perform different embodiments of the inventive method. Buffer 110 is a buffer memory coupled to receive an encoded input audio bitstream. In operation, buffer 110 stores (e.g., in a non-transitory manner) at least one segment (e.g., frame) of the encoded audio bitstream, and a sequence of the segments (e.g., frames) of the encoded audio bitstream is asserted from buffer 110 to parser 111.

Parser 111 is coupled and configured to extract metadata (e.g., loudness processing state metadata or “LPSM”) from each segment (e.g., frame) of the encoded input audio, to assert at least the LPSM to audio state validator 102, loudness processing stage 103, stage 106 and subsystem 108, to extract audio data from the encoded input audio, and to assert the audio data to decoder 101. Decoder 101 of encoder 100 is configured to decode the audio data to generate decoded audio data, and to assert the decoded audio data to loudness processing stage 103, audio stream selection stage 104, subsystem 108, and typically also to state validator 102.

State validator 102 is configured to authenticate and validate the LPSM (and optionally other metadata) asserted thereto. In some embodiments, the LPSM is (or is included in) a data block that has been included in the input bitstream (e.g., in accordance with an embodiment of the present invention). The block may comprise a cryptographic hash (a hash-based message authentication code or “HMAC”) for processing the LPSM (and optionally also other metadata) and/or the underlying audio data (provided from decoder 101 to validator 102). The data block may be digitally signed in these embodiments, so that a downstream audio processing unit may relatively easily authenticate and validate the processing state metadata.

For example, the HMAC is used to generate a digest, and the protection value(s) included in the inventive bitstream may include the digest.

Other cryptographic methods including but not limited to any of one or more non-HMAC cryptographic methods may be used for validation of LPSM (e.g., in validator 102) to ensure secure transmission and receipt of the LPSM and/or the underlying audio data. For example, validation (using such a cryptographic method) can be performed in each audio processing unit which receives an embodiment of the inventive audio bitstream to determine whether the loudness processing state metadata and corresponding audio data included in the bitstream have undergone (and/or have resulted from) specific loudness processing (as indicated by the metadata) and have not been modified after performance of such specific loudness processing.

State validator 102 asserts control data to audio stream selection stage 104, supplementary data generator 106, and dialog loudness measurement subsystem 108, to indicate the results of the validation operation. In response to the control data, stage 104 may select (and pass through to encoder 105) either:

the adaptively processed output of loudness processing stage 103 (e.g., when the LPSM indicate that the audio data output from decoder 101 have not undergone a specific type of loudness processing, and the control bits from validator 102 indicate that the LPSM are valid); or

the audio data output from decoder 101 (e.g., when the LPSM indicate that the audio data output from decoder 101 have already undergone the specific type of loudness processing that would be performed by stage 103, and the control bits from validator 102 indicate that the LPSM are valid).

Stage 103 of encoder 100 is configured to perform adaptive loudness processing on the decoded audio data output from decoder 101, based on one or more audio data characteristics indicated by LPSM extracted by decoder 101. Stage 103 may be an adaptive transform-domain real time loudness and dynamic range control processor. Stage 103 may receive user input (e.g., user target loudness/dynamic range values or dialnorm values), or other metadata input (e.g., one or more types of third party data, tracking information, identifiers, proprietary or standard information, user annotation data, user preference data, etc.) and/or other input (e.g., from a fingerprinting process), and use such input to process the decoded audio data output from decoder 101.

Dialog loudness measurement subsystem 108 may operate to determine loudness of segments of the decoded audio (from decoder 101) which are indicative of dialog (or other speech), e.g., using the LPSM (and/or other metadata) extracted by decoder 101, when the control bits from validator 102 indicate that the LPSM are invalid. Operation of dialog loudness measurement subsystem 108 may be disabled when the LPSM indicate previously determined loudness of dialog (or other speech) segments of the decoded audio (from decoder 101) when the control bits from validator 102 indicate that the LPSM are valid.

Useful tools (e.g., the Dolby LM100 loudness meter) exist for measuring the level of dialog in audio content conveniently and easily. Some embodiments of the inventive APU (e.g., stage 108 of encoder 100) are implemented to include (or to perform the functions of) such a tool to measure the mean dialog loudness of audio content of an audio bitstream (e.g., a decoded AC-3 bitstream asserted to stage 108 from decoder 101 of encoder 100).

If stage 108 is implemented to measure the true mean dialog loudness of audio data, the measurement may include a step of isolating segments of the audio content that predominantly contain speech. The audio segments that predominantly are speech are then processed in accordance with a loudness measurement algorithm. For audio data decoded from an AC-3 bitstream, this algorithm may be a standard K-weighted loudness measure (in accordance with the international standard ITU-R BS.1770). Alternatively, other loudness measures may be used (e.g., those based on psychoacoustic models of loudness).

The isolation of speech segments is not essential to measure the mean dialog loudness of audio data. However, it improves the accuracy of the measure and typically provides more satisfactory results from a listener's perspective. Because not all audio content contains dialog (speech), the loudness measure of the whole audio content may provide a sufficient approximation of the dialog level of the audio, had speech been present.

Supplementary data generator 106 generates (and/or passes through) supplementary data (e.g., metadata) to be included by stage 107 in the encoded bitstream to be output from encoder 100. Supplementary data generator 106 may pass through to stage 107 the LPSM (and/or other metadata) extracted by encoder 101 (e.g., when control bits from validator 102 indicate that the LPSM and/or other metadata are valid), and/or may pass through to stage 107 supplementary data (e.g., additional channels of audio data and/or metadata) received from an external source, and/or may generate new LPSM (and/or other metadata) and assert the new metadata to stage 107 (e.g., when control bits from validator 102 indicate that the LPSM and/or other metadata extracted by decoder 101 are invalid). Supplementary data generator 106 may include loudness data generated by subsystem 108, and at least one value indicative of the type of loudness processing performed by subsystem 108, in LPSM which it asserts to stage 107 for inclusion in the encoded bitstream to be output from encoder 100.

Supplementary data generator 106 may generate protection bits (which may consist of or include a hash-based message authentication code or “HMAC”) useful for at least one of decryption, authentication, or validation of supplementary data (e.g., LPSM or other metadata) to be included in the encoded bitstream and/or corresponding (or unrelated) audio data to be included in the encoded bitstream. Supplementary data generator 106 may provide such protection bits to stage 107 for inclusion in the encoded bitstream.

In typical operation, dialog loudness measurement subsystem 108 processes the audio data output from decoder 101 to generate in response thereto loudness values (e.g., gated and ungated dialog loudness values) and dynamic range values. In response to these values, supplementary data generator 106 may generate loudness processing state metadata (LPSM) for inclusion (by stuffer/formatter 107) into the encoded bitstream to be output from encoder 100.

Additionally, optionally, or alternatively, subsystems of 106 and/or 108 of encoder 100 may perform additional analysis of the audio data to generate metadata indicative of at least one characteristic of the audio data for inclusion in the encoded bitstream to be output from stage 107.

Encoder 105 encodes (e.g., by performing compression thereon) the audio data output from selection stage 104, and asserts the encoded audio to stage 107 for inclusion in the encoded bitstream to be output from stage 107.

Stage 107 multiplexes the encoded audio from encoder 105 and the supplementary data (typically including LPSM, protection bits, and/or other metadata) from generator 106 to generate the encoded bitstream to be output from stage 107, preferably so that the encoded bitstream has format as specified by a preferred embodiment of the present invention.

Buffer 109 is a buffer memory which stores (e.g., in a non-transitory manner) at least one segment (e.g., burst or frame) of the encoded audio bitstream output from stage 107, and a sequence of the segments (e.g., bursts) of the encoded audio bitstream is then asserted from buffer 109 as output from encoder 100 to delivery system 150.

LPSM generated by supplementary data generator 106 and included in the encoded bitstream by stage 107 is indicative of the loudness processing state of corresponding audio data (e.g., what type(s) of loudness processing have been performed on the audio data) and loudness (e.g., measured dialog loudness, gated and/or ungated loudness, and/or dynamic range) of the corresponding audio data.

Herein, “gating” of loudness and/or level measurements performed on audio data refers to a specific level or loudness threshold where computed value(s) that exceed the threshold are included in the final measurement (e.g., ignoring short term loudness values below −60 dBFS in the final measured values). Gating on an absolute value refers to a fixed level or loudness, whereas gating on a relative value refers to a value that is dependent on a current “ungated” measurement value.

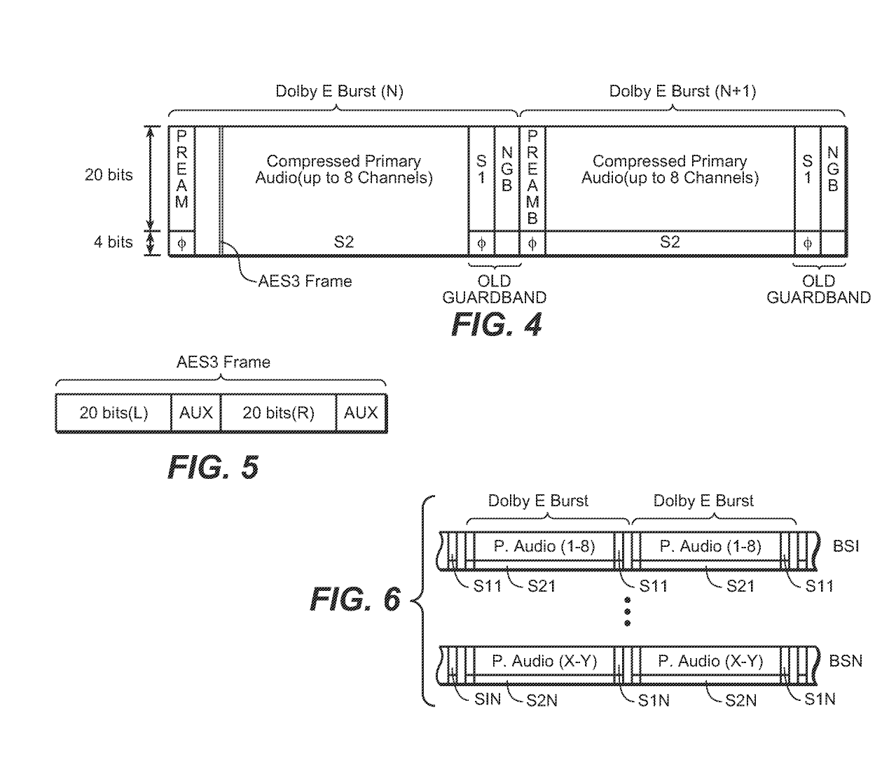

In some implementations of encoder 100, the encoded bitstream buffered in memory 109 (and output to delivery system 150) is a Dolby E bitstream, and comprises bursts having structure as shown in FIG. 4. In some implementations, some of the supplementary data inserted by stage 107 into a burst of the bitstream is included in the four LSBs of each of the two AES3 subframes of each AES3 frame of the burst (supplementary data “S2” of FIG. 4 is an example of such supplementary data), some of the supplementary data (e.g., core element(s), of the type described below, of the supplementary data) is included in the first X sample locations of the guard band interval of the burst (supplementary data “S1” of FIG. 4 is an example of such supplementary data), and the primary audio data inserted by stage 107 into the burst is included in the 20 most significant bits (MSBs) of each of the two AES3 sub-frames of each AES3 frame of the burst.

In some implementations, the supplementary data inserted by stage 107 into a burst of the encoded bitstream has the following format:

a core header (typically including a syncword identifying the start of supplementary data of one type, followed by identification values, e.g., core element version, length, and period, extended element count, and substream association values); and

after the core header, at least one protection value (e.g., an HMAC digest and Audio Fingerprint values, where the HMAC digest may be a 256-bit HMAC digest (e.g., using SHA-2 algorithm) computed over primary audio data, and the core element and all expanded elements of supplementary data of the relevant type, of an entire burst) useful for at least one of decryption, authentication, or validation of at least one of supplementary data or corresponding audio data); and

also after the core header, if the supplementary data includes metadata, metadata payload identification (“ID”) and payload size values which identify following metadata as a payload of some indicated type and indicate size of the payload; and

also after the core header (e.g., after the payload ID and payload size values), a supplementary data payload (or container).

If more than one type of metadata is included in the supplementary data in the burst, such core header, protection value(s), and payload identification (“ID”) and payload size values are provided for each type of metadata, and are sometimes referred to herein as the “core element” of the metadata (of the relevant type). In some implementations, each core element inserted (by stage 107) into a burst is inserted in the first X sample locations of the burst's guard band interval (in the location of supplementary data “S1” of FIG. 4).

In some embodiments of the type described in the two previous paragraphs, the supplementary data inserted by stage 107 into a burst has three levels of structure:

a high level structure, including a flag indicating whether the burst (e.g., the LSBs of AES3 subframes of the burst and/or a guard band of the burst) includes metadata, at least one ID value indicating what type(s) of metadata are present, and typically also a value indicating how many bits of metadata (e.g., of each type) are present (if metadata is present). One type of metadata that could be present is processing state metadata (e.g., loudness processing state metadata), another type of metadata that could be present is indicative of at least one characteristic of an audio object, and another type of metadata that could be present is ratings metadata;

an intermediate level structure, comprising a core element for each identified type of metadata (e.g., core header, protection values, and payload ID and payload size values, e.g., of the type mentioned above, for each identified type of metadata); and

a low level structure, comprising each payload for one core element (e.g., a processing state metadata payload, if one is identified by the core element as being present, and/or a metadata payload of another type, if one is identified by the core element as being present).

The data values in such a three level structure can be nested. For example, the protection value(s) for an LPSM payload and/or another metadata payload identified by a core element can be included after each payload identified by the core element (and thus after the core header of the core element). In one example, a core header could identify an LPSM payload and another metadata payload, payload ID and payload size values for the first payload (e.g., the LPSM payload) could follow the core header, the first payload itself could follow the ID and size values, the payload ID and payload size value for the second payload could follow the first payload, the second payload itself could follow these ID and size values, and protection bits for both payloads (or for core element values and both payloads) could follow the last payload.

In some embodiments, if decoder 101 (of FIG. 1) receives an audio bitstream generated in accordance with an embodiment of the invention with cryptographic hash, the decoder is configured to parse and retrieve the cryptographic hash from a data block determined from the bitstream, said block comprising loudness processing state metadata (LPSM). Validator 102 may use the cryptographic hash to validate the received bitstream and/or associated metadata. For example, if validator 102 finds the LPSM to be valid based on a match between a reference cryptographic hash and the cryptographic hash retrieved from the data block, then it may disable operation of processor 103 on the corresponding audio data and cause selection stage 104 to pass through (unchanged) the audio data. Additionally, optionally, or alternatively, other types of cryptographic techniques may be used in place of a method based on a cryptographic hash.

Encoder 100 of FIG. 2 may determine (in response to LPSM extracted by decoder 101) that a post/pre-processing unit has performed a type of loudness processing on the audio data to be encoded (in elements 105, 106, and 107) and hence may create (in generator 106) loudness processing state metadata that includes the specific parameters used in and/or derived from the previously performed loudness processing. In some implementations, encoder 100 may create (and include in the encoded bitstream output therefrom) processing state metadata indicative of processing history on the audio content so long as the encoder is aware of the types of processing that have been performed on the audio content.

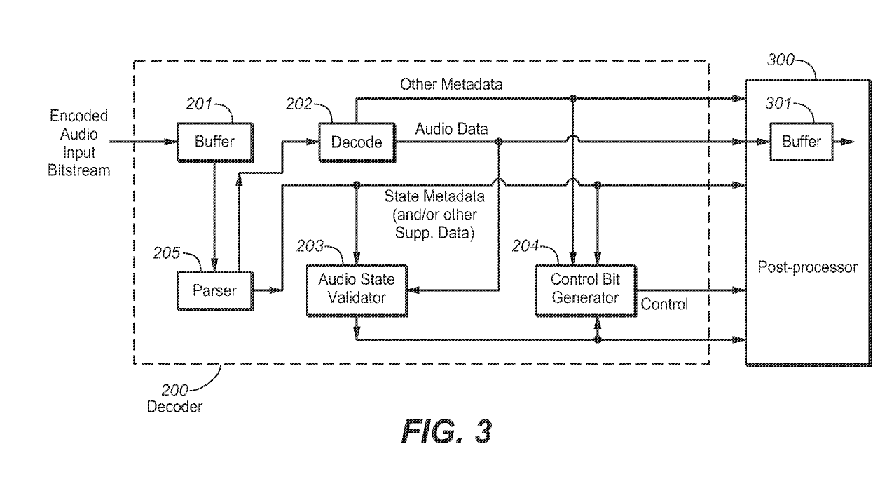

FIG. 3 is a block diagram of a decoder (200) which is an embodiment of the inventive audio processing unit, and of a post-processor (300) coupled thereto. Post-processor (300) is also an embodiment of the inventive audio processing unit. Any of the components or elements of decoder 200 and post-processor 300 may be implemented as one or more processes and/or one or more circuits (e.g., ASICs, FPGAs, or other integrated circuits), in hardware, software, or a combination of hardware and software. Decoder 200 comprises buffer 201, parser 205, audio decoder 202, audio state validation stage (validator) 203, and control bit generation stage 204, connected as shown. Typically also, decoder 200 includes other processing elements (not shown).

Buffer 201 (a buffer memory) stores (e.g., in a non-transitory manner) at least one segment (e.g., burst or frame) of the encoded audio bitstream received by decoder 200. A sequence of the frames of the encoded audio bitstream is asserted from buffer 201 to parser 205.

Parser 205 is coupled and configured to extract supplementary data (e.g., loudness processing state metadata (LPSM) and other metadata) from each frame of the encoded input audio, to assert at least the LPSM to audio state validator 203 and stage 204, to assert the LPSM as output (e.g., to post-processor 300), to extract audio data from the encoded input audio, and to assert the extracted audio data to decoder 202.

The encoded audio bitstream input to decoder 200 may be a Dolby E bitstream (e.g., including supplementary data S1 and S2 in the format shown in FIG. 4).

The system of FIG. 3 also includes post-processor 300. Post-processor 300 comprises frame buffer 301 and other processing elements (not shown) including at least one processing element coupled to buffer 301. Frame buffer 301 stores (e.g., in a non-transitory manner) at least one frame of the decoded audio data received by post-processor 300 from decoder 200. Processing elements of post-processor 300 are coupled and configured to receive and adaptively process a sequence of the frames of the decoded audio data output from buffer 301, using metadata (including LPSM values) output from decoder 202 and/or control bits output from stage 204 of decoder 200. Typically, post-processor 300 is configured to perform adaptive loudness processing on the decoded audio data using the LPSM values (e.g., based on loudness processing state, and/or one or more audio data characteristics, indicated by LPSM).

Various implementations of decoder 200 and post-processor 300 are configured to perform different embodiments of the inventive method.

Audio decoder 202 of decoder 200 is configured to decode the audio data extracted by parser 205 to generate decoded audio data, and to assert the decoded audio data as output (e.g., to post-processor 300).

State validator 203 is configured to authenticate and validate the LPSM (and optionally other supplementary data) asserted thereto. In some embodiments, the supplementary data is (or is included in) a data block that has been included in the input bitstream (e.g., in accordance with an embodiment of the present invention). The block may comprise a cryptographic hash (a hash-based message authentication code or “HMAC”) for processing the supplementary data and/or primary audio data (provided from parser 205 and/or decoder 202 to validator 203). The data block may be digitally signed in these embodiments, so that a downstream audio processing unit may relatively easily authenticate and validate the processing state metadata.

Other cryptographic methods including but not limited to any of one or more non-HMAC cryptographic methods may be used for validation of supplementary data (e.g., in validator 203) to ensure secure transmission and receipt of the supplementary data and/or primary audio data. For example, validation (using such a cryptographic method) can be performed in each audio processing unit which receives an embodiment of the inventive audio bitstream to determine whether loudness processing state metadata and corresponding audio data included in the bitstream have undergone (and/or have resulted from) specific loudness processing (as indicated by the metadata) and have not been modified after performance of such specific loudness processing.

State validator 203 asserts control data to control bit generator 204, and/or asserts the control data as output (e.g., to post-processor 300), to indicate the results of the validation operation. In response to the control data (and optionally also other metadata extracted from the input bitstream), stage 204 may generate (and assert to post-processor 300) either:

control bits indicating that decoded audio data output from decoder 202 have undergone a specific type of loudness processing (when LPSM indicate that the audio data output from decoder 202 have undergone the specific type of loudness processing, and the control bits from validator 203 indicate that the LPSM are valid); or

control bits indicating that decoded audio data output from decoder 202 should undergo a specific type of loudness processing (e.g., when LPSM indicate that the audio data output from decoder 202 have not undergone the specific type of loudness processing, or when the LPSM indicate that the audio data output from decoder 202 have undergone the specific type of loudness processing but the control bits from validator 203 indicate that the LPSM are not valid).

Alternatively, decoder 200 asserts LPSM (and/or any other metadata or other supplementary data) extracted by decoder 202 from the input bitstream to post-processor 300, and post-processor 300 performs processing on the decoded audio data using the supplementary data (e.g., it performs loudness processing on the decoded audio data using LPSM included in the supplementary data), or performs validation of the LPSM and then performs loudness processing on the decoded audio data using the LPSM if the validation indicates that the LPSM are valid.

In some embodiments, if decoder 201 receives an audio bitstream generated in accordance with an embodiment of the invention with cryptographic hash, the decoder is configured to parse and retrieve the cryptographic hash from a data block determined from the bitstream, said block comprising supplementary data (typically including LPSM). Validator 203 may use the cryptographic hash to validate the received bitstream and/or associated supplementary data. For example, if validator 203 finds the supplementary data to be valid based on a match between a reference cryptographic hash and the cryptographic hash retrieved from the data block, then it may signal to a downstream audio processing unit (e.g., post-processor 300, which may be or include a volume leveling unit) to pass through (unchanged) the audio data of the bitstream. Additionally, optionally, or alternatively, other types of cryptographic techniques may be used in place of a method based on a cryptographic hash.

More generally, the encoded audio bitstream generated by preferred embodiments of the invention has a structure which provides a mechanism to label supplementary data elements and sub-elements (included in the bitstream) as core (mandatory) or expanded (optional elements). This allows the data rate of the bitstream (including its supplementary data) to scale across numerous applications. The core (mandatory) elements of the preferred bitstream syntax are preferably also capable of signaling that expanded (optional) elements (which may be associated with primary audio content of the bitstream) are present (in-band) and/or in a remote location (out of band).

Core element(s) are required to be present in every segment (burst or frame) of the bitstream. Some sub-elements of core elements are optional and may be present in any combination. Expanded elements are not required to be present in every segment (to limit bitrate overhead). Thus, expanded elements may be present in some segments and not others. Some sub-elements of an expanded element are optional and may be present in any combination, whereas some sub-elements of an expanded element may be mandatory (i.e., if the expanded element is present in a segment of the bitstream).

FIG. 4 is a diagram of a Dolby E bitstream comprising a sequence of Dolby E bursts (sometimes referred to as Dolby E frames), each of the bursts including supplementary data in accordance with an embodiment of the invention. Each Dolby E burst includes a sequence of data structures, each having the format of AES3 frame. One such data structure (labeled AES3 frame in FIG. 4) is shown in greater detail in FIG. 5. As shown in FIG. 5, the AES3 frame includes two subframes: a first subframe including a 20-bit audio sample for a first channel (e.g., a left channel, labeled “L” in FIG. 5) and 4 auxiliary bits (labeled “Aux” in FIG. 5); and a second subframe including a second 20-bit audio sample (e.g., for a second channel, which may be a right channel, is indicated by the label “R” in FIG. 5) and 4 auxiliary bits (also labeled “Aux” in FIG. 5). The auxiliary bits in each subframe are the four least significant bits of the subframe, and are typically not used (e.g., are typically set to zeros) and carry no useful information.

Each subframe of each of the data structures, of some embodiments of the inventive bitstream, having the format of an AES3 frame may include a 4-bit preamble, a sample for one audio channel (e.g., a Left or Right stereo channel), and a trailing 4-bit field (validity bit, user data bit, channel status bit, and parity bit). A conventional AES3 frame comprises two 24-bit samples of LPCM audio data. More specifically, it includes two subframes: one subframe including a 4-bit preamble, one 24-bit sample for one audio channel (e.g., a Left stereo channel), and a trailing 4-bit field (validity bit, user data bit, channel status bit, and parity bit); the other subframe including a 4-bit preamble, one 24-bit sample for another audio channel (e.g., a Right stereo channel), and a trailing 4-bit field (validity bit, user data bit, channel status bit, and parity bit).

The encoded bitstream of FIG. 4 comprises a sequence of frames (referred to herein as “AES3 frames”), each of the frames having two audio segments (referred to herein as “AES3 subframes”), and each of the audio segments comprises 24 bits.

Each Dolby E burst of the encoded bitstream of FIG. 4 comprises a preamble comprising 20-bit words (the 4 LSBs of each preamble word are not used and thus are indicated as “0” in FIG. 4), followed by a sequence of AES3 frames, followed by sequence of 24-bit data words in the location of a conventional guard band (labeled “Old Guardband” in FIG. 4).

In accordance with an embodiment of the invention, the primary audio data of the FIG. 4 bitstream is carried as a sequence of 20-bit words (the 20 MSBs of each AES3 subframe) following the preamble and preceding the “Old Guardband.” The bitstream also includes supplementary data (labeled “S2” in FIG. 4) in the 4 least significant bits of each AES3 subframe following the preamble and preceding the “Old Guardband.” The FIG. 4 bitstream also includes supplementary data (labeled “S1” in FIG. 4) the first “X” 24-bit data words in the “Old Guardband.” More specifically, the “S1” supplementary data is included in the 20 MSBs of each of the first “X” 24-bit data words in the “Old Guardband.” The 4 LSBs of each 24-bit data word in the “Old Guardband” are not used and thus are indicated as “0” in FIG. 4). The “S1” supplementary data in each burst of the FIG. 4 bitstream can consist of (or include) the “core element” (described above) of a segment of the supplementary data included in the bitstream. Typically, a conventional guard band includes S guard band samples (where S≧80), and the “S1” supplementary data are included in the first X guard band sample locations, where “X” is less than (e.g., substantially less) than S (e.g., X=20). Conventional guard band samples (typically, zero or “silent” samples) occupy the remaining (S minus X) sample locations of the Old Guardband, so that each burst of the FIG. 4 bitstream includes a reduced-size guard band (labeled “NGB” in FIG. 4 to denote “new guard band”) comprising “S minus X” conventional, 24-bit guard band samples (which are typically zero or “silent” samples).

The audio data carried by a conventional audio data burst having SMPTE 337 format is non-PCM data. An example is the Dolby E audio data carried by each Dolby E burst of the FIG. 4 sequence of Dolby E bursts. Each conventional audio data burst having SMPTE 337 format is indicative of up to eight channels of non-PCM audio, and thus each Dolby E burst of the FIG. 4 sequence of Dolby E bursts is indicative of up to eight channels of non-PCM (compressed) primary audio data and up to eight channels of non-PCM supplementary data (i.e., the S2 supplementary data in each Dolby E burst of FIG. 4 can include up to eight channels of supplementary data, each of which may be indicative of or otherwise corresponding to one of the channels of primary audio data).

Some embodiments of the inventive bitstream (including a sequence of data bursts having SMPTE 337 format, i.e., “Dolby E” type bursts, each including a sequence of data structures having the format of AES3 frames) include non-PCM supplementary data (e.g., metadata and/or additional audio data) that are not included in a conventional Dolby E bitstream. At least some of the supplementary data (e.g., the “S2” supplementary data of FIG. 4) can be carried in the 4 least significant bits (LSBs) of each 24-bit sample of each of at least some of the “AES3 frame” type data structures. At least some of the supplementary data (e.g., the “S1” supplementary data of FIG. 4) can be carried in at least one guard band location of the bitstream (e.g., in full 24-bit words of the guard band, or in the 20 MSBs of each word of each of the first few 24-bit words of the guard band). For example, the “core element” (described above) of a segment of the supplementary data can be in such a guard band location (i.e., the “S1” supplementary data of FIG. 4 can include or consist of at least one such core element).

In some embodiments, the preamble of a burst of the inventive bitstream (e.g., the preamble of each Dolby E burst of the FIG. 4 bitstream) includes a flag indicating whether the AES3 frames of the burst include supplementary data in the 4 LSBS of each AES3 subframe (and thus whether each AES3 subframe includes 20 bits of audio, or 24 bits of audio and supplementary data), and a value indicating the length (number of bits) of audio and supplementary data included in the burst. In a preferred format, the encoded bitstream generated in accordance with an embodiment of the invention is a Dolby E bitstream, and a value indicative of supplementary data payload length (of each burst) is signaled in the Pd word of the SMPTE 337M preamble of the burst (the SMPTE 337M Pa word repetition rate preferably remains identical to associated video frame rate). A decoder may use such values in the preamble of each burst to maintain synchronization. Alternatively, the supplementary data (e.g., the “S1” and/or “S2” supplementary data of FIG. 4) included in a burst of the inventive bitstream (or in an embodiment of the inventive bitstream whose AES3 frames are not organized into bursts) may include data (e.g., at least one synchronization word and/or protection bits) useful by a decoder to maintain synchronization.

As noted above, a class of embodiments of the invention provides methods and a framework for extending distribution codecs (e.g., those compliant with Dolby E, or which support the SMPTE 337 format for carrying non-pcm audio and data in an AES3 serial digital audio bitstream) to scale beyond the current channel limit of 8 channels to support multiples of 8 channels synchronously across multiple AES3 interfaces. This is done by generating a set of N of the inventive AES3 bitstreams, where N is a positive integer (e.g., N=1, 2, or 6), and typically also transmitting the N bitstreams in parallel. FIG. 6 represents an example of such a set of AES3 bitstreams, in which each of the bitstreams has the format shown in (and described with reference to) FIG. 4. In the set of N Dolby E bitstreams of FIG. 4, each bitstream comprises a sequence of Dolby E bursts, and each of said bursts including supplementary data in accordance with an embodiment of the invention. The first bitstream in the set (“BSI”) includes supplementary data in auxiliary bit locations (supplementary data S21) and in guard band locations (supplementary data S11). Similarly, the “N”th bitstream in the set (“BSN”) includes supplementary data in auxiliary bit locations (supplementary data S2N) and in guard band locations (supplementary data S1N).

In the embodiments mentioned in the previous paragraph, each of the bitstreams in the set comprises a sequence of bursts, where each burst carries audio data (e.g., primary audio data) and the inventive supplementary data (e.g., metadata indicative of at least one feature or characteristic of primary audio data) in SMPTE 337 format, and each burst typically occupies a time period equivalent to that of a corresponding video frame. Typically, each bitstream includes non-PCM audio data (indicative of up to eight channels of PCM audio) and/or non-PCM supplementary data. Typically, the supplementary data of one or more of the bitstreams includes metadata (and/or protection bits) shared by all the bitstreams. The supplementary data of each of the bitstreams can include synchronization words which can be used to time align the supplementary data and audio data of all N of the bitstreams, and/or to synchronize the supplementary data and audio data with corresponding video frames. Such synchronization information is typically computed (and carried in every burst) when a set of two or more of the inventive bitstreams or files (e.g., multiple bitstreams or files, each including encoded audio data and associated supplementary data, formatted as per SMPTE 337) encode more than eight channels (e.g., speaker channels and/or objects or object channels), and the synchronization information is utilized by the decoder (or other processes) to maintain time-alignment across all the encoded bitstreams/files. Alternatively, in some embodiments, each of a set of N of the inventive bitstreams (or files) can include a preamble (or other data structure), which does not include inventive supplementary data, but which includes at least one synchronization word (e.g., the synchronization bits of the preamble of a conventional Dolby E burst) which can be used to time align the supplementary data and audio data of all N of the bitstreams (or files), and/or to synchronize the supplementary data and audio data with corresponding video frames.

In other embodiments, the inventive bitstream is an AES3 serial digital audio bitstream (AES3 bitstream) which carries audio data and supplementary data in a sequence of frames, each of the frames has the structure of an AES3 frame, the frames are not organized as a sequence of bursts (e.g., bursts each corresponding to a time period equivalent to that of a corresponding video frame). The primary audio data and supplemental data in each of the frames is LPCM (linear pulse code modulated) or other PCM data.

For example, a class of embodiments does not rely on the use of an underlying distribution codec and instead provides a mechanism to carry N sets of supplementary data (e.g., audio object channel/speaker channel/metadata combinations) in a set of N AES3 bitstreams, where N is a positive integer (e.g., N=1, 2, or 8). Each AES3 bitstream is indicative of two channels of 20-bit LPCM (linear pulse code modulated) audio data. More specifically, each AES3 bitstream carries audio data and supplementary data in a sequence of frames, each of the frames has the structure of an AES3 frame (including two subframes, each containing a 20-bit LPCM audio sample). The supplementary data (typically including object/speaker channel metadata and protection bits) is LPCM data carried in each of the auxiliary bit fields of the frames (i.e., as the four least significant bits in each AES3 subframe of each frame). Typically, the supplementary data includes synchronization words which can be used to time align the supplementary data and audio data of all N of the bitstreams, and/or to synchronize the supplementary data and audio data with corresponding video frames. In cases in which the input LPCM samples (presented to the encoder) would occupy all 24 bits of each AES3 subframe (e.g., where each input sample is a 20-bit audio sample payload plus four auxiliary bits), the encoder may dither the input samples to 20-bit values, and then write one of the dithered 20-bit values (with four bits of supplementary data) into each of at least some of the AES3 subframes of the bitstream in accordance with the invention. The decoder would reverse this process at the direction of a ‘dither’ flag carried in the supplementary data stream.

In a class of embodiments, the inventive bitstream/file format includes supplementary data (e.g., metadata having a core element including protection bit fields) in one, some, or all of the available 2-channel AES3 samples of the guard band between two bursts of AES3 frames (e.g., Dolby E bursts), and/or in each of at least some of the auxiliary bit fields (i.e., 4 least significant bits of each sample of each AES3 subframe) within each of a sequence of AES3 frames (e.g., of a Dolby E burst). In some such embodiments, the inventive bitstream is a Dolby E compliant bitstream.

In some embodiments in this class, the inventive bitstream is a Dolby E stream including the inventive supplementary data, and each Dolby E burst of the stream can include samples of up to 8 different primary audio channels (and auxiliary bits indicating to which primary audio channel each sample belongs) and a set of supplementary data corresponding to each of the primary audio channels (i.e., up to 8 sets of supplementary data). For example, each set of supplementary data in the Dolby E burst could consist of (or include) metadata for a different one of the primary audio channels. For another example, each set of supplementary data in the Dolby E burst could consist of (or include) a different supplementary audio channel (e.g., an object based audio program, or object channel thereof, or a speaker channel) unrelated to the corresponding primary audio channel (and optionally also metadata for such a supplementary audio channel).

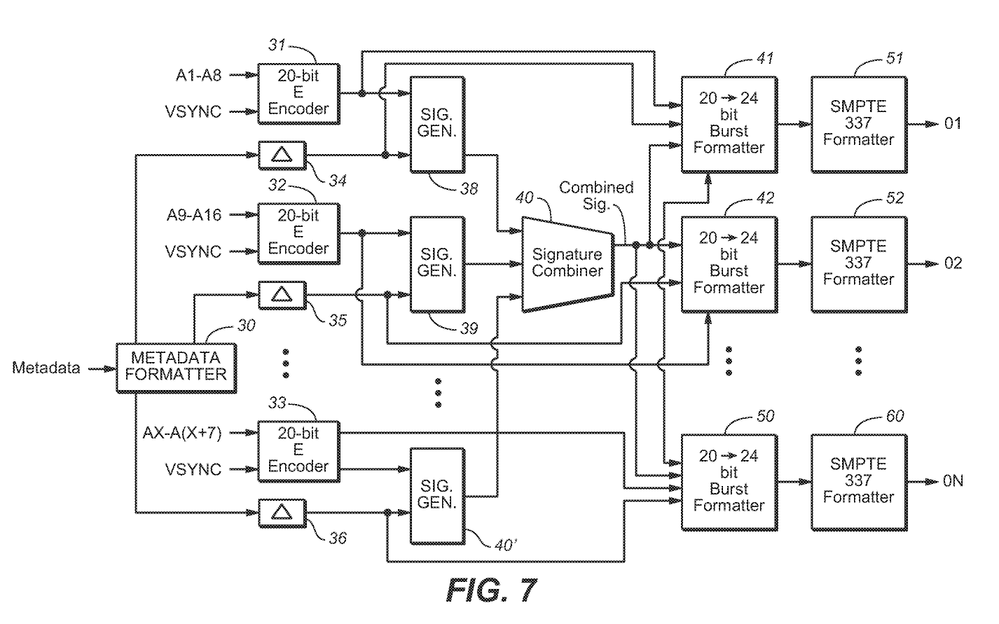

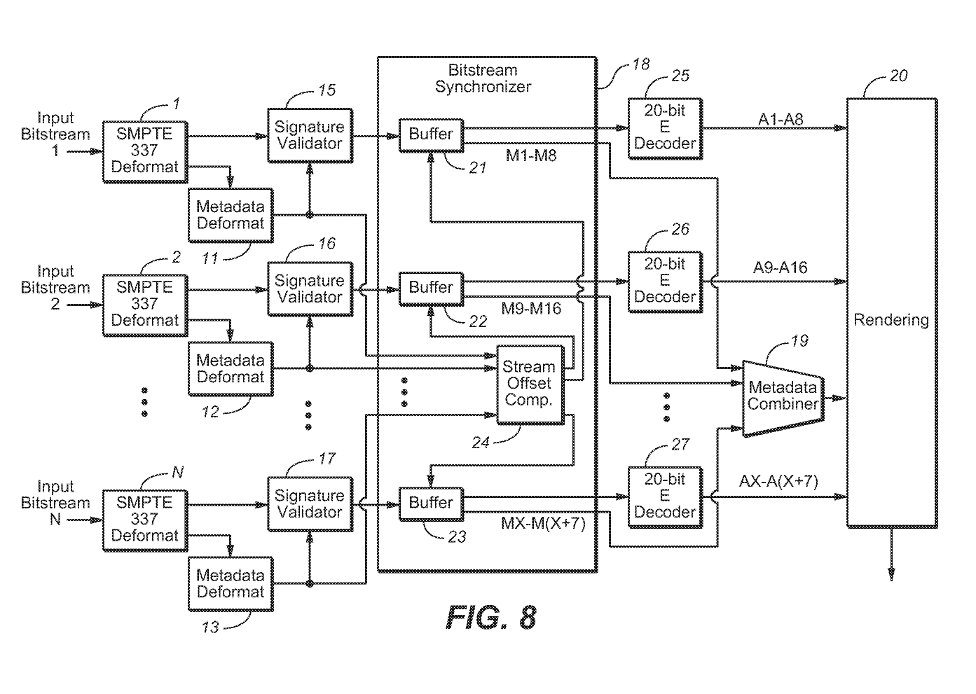

A system for encoding or decoding the inventive bitstream(s) can be implemented (scaled) to process more than a single bitstream (e.g., a single Dolby E stream including the inventive supplementary data) to support 8N sets of supplementary data (e.g., object/speaker channel audio data and/or metadata combinations), where N is an integer greater than one. To do so, a set of N of the inventive bitstreams is generated and disseminated (or received and processed) in parallel, and each of the bitstreams carries up to 8 sets of supplementary data. The systems to be described with reference to FIGS. 7 and 8 are examples of such systems.

In a class of embodiments, the inventive encoding (e.g., transcoding) or decoding system maintains frame alignment (sync) across sets of supplementary data in different ones of a set of parallel bitstreams utilizing core element protection bits included in the supplementary data in each of the bitstreams. Such protection bits are typically generated with HMAC/HASH computations during the encoding process. Typically, the protection bits (e.g., HASH bits) for each of the bitstreams are labeled in a core element (of the supplementary data carried by the bitstream) and are also carried in all of the core elements of the supplementary data of all the bitstreams. The protection bits for each segment (e.g., burst or frame) of each bitstream are utilized during the decode process (or in a post processing step following the decode process) to compare against an identical HMAC/HASH operation at the decoder taken over the same number of samples and supplementary data. The outcome of this process and comparison (to the protection bits inserted into the supplementary data during the encode process) is utilized to correct any frame/bitstream misalignment (due to the likelihood that tight synchronism among them is lost in distribution/contribution since each bitstream is carried over an independent AES3 real-time interface and/or track within a media file).

The protection bits computed and carried in each burst (or across a block of samples) of one of the bitstreams are unique and thus can be leveraged for a secondary purpose (in addition to determining the validity of the supplementary data and audio content). In some embodiments, these bits serve the additional purpose of providing a mechanism to maintain sync among N bitstreams and/or bursts of one or more bitstreams carrying supplemental data (e.g., audio object/channel/metadata combinations).

We next describe an embodiment of the inventive encoding system with reference to FIG. 7. In this exemplary embodiment, the encoding system generates a set of N encoded bitstreams (labeled O1, O2, . . . , ON in FIG. 7). Each of the N bitstreams is indicative of a different set of primary audio data and each includes supplementary data in accordance with the invention. The supplementary data included in each of the bitstreams is indicative of a subset of a set of metadata which is input to metadata formatter stage 30, and protection bits generated in signature generation elements (e.g., elements 38, 39, and 40′) of the FIG. 7 encoder.

As indicated in FIG. 7, eight channels (A1-A8) of primary data, and a video frame synchronization signal (VSYNC), are asserted to inputs of 20-bit Dolby E encoder 31. Encoder 31 is configured to output, in response, a sequence of 20-bit code words to be included in each Dolby E burst of the first one (“O1”) of the N bitstreams. The 20-bit code words output from encoder 31 indicate samples of each of the primary data channels A1-A8 to be transmitted in one of the bursts (corresponding to a time period equivalent to that of a corresponding video frame). The 20-bit code words are asserted from encoder 31 to signature generator 38 and formatter 41.

Similarly, eight other channels (A9-A16) of primary data, and a video frame synchronization signal (VSYNC), are asserted to inputs of 20-bit Dolby E encoder 32. Encoder 32 is configured to output, in response, a sequence of 20-bit code words to be included in each Dolby E burst of the second one (“O2”) of the N bitstreams. The 20-bit code words output from encoder 32 indicate samples of each of the primary data channels A9-A16 to be transmitted in each burst of the bitstream (each burst corresponding to a time period equivalent to that of a corresponding video frame). The 20-bit code words are asserted from encoder 32 to signature generator 39 and formatter 42.

Similarly, the last eight channels (AX-A(X+7)) of primary data, and a video frame synchronization signal (VSYNC), are asserted to inputs of 20-bit Dolby E encoder 33. Encoder 33 is configured to output, in response, a sequence of 20-bit code words to be included in each Dolby E burst of the “N”th one (“ON”) of the output bitstreams. The 20-bit code words output from encoder 33 indicate samples of each of the primary data channels AX-A(X+7) to be transmitted in each burst of the bitstream (each burst corresponding to a time period equivalent to that of a corresponding video frame). The 20-bit code words are asserted from encoder 33 to signature generator 40′ and formatter 50.

Similarly, for each of the other output bitstreams (“O3” through “O(N−1)”), eight other channels of primary data, and a video frame synchronization signal (VSYNC), are asserted to inputs of a 20-bit Dolby E encoder (not shown, but coupled in parallel with encoders 31, 32, and 33). This encoder is configured to output, in response, a sequence of 20-bit code words to be included in each Dolby E burst of the relevant one of the N output bitstreams. The 20-bit code words output from the encoder indicate samples of the relevant set of eight primary data channels to be transmitted in each burst of the bitstream (each burst corresponding to a time period equivalent to that of a corresponding video frame). The 20-bit code words are asserted from the encoder to a corresponding signature generator coupled in parallel with generators 38, 39, and 40′, and to a corresponding 20-to-24 bit burst formatter coupled in parallel with formatters 41, 42, and 50.

Metadata formatter stage 30 is configured to generate a sequence of 4-bit metadata words to be included in each Dolby E burst of each one of the N output bitstreams. For example, stage 30 is configured to generate a sequence of 4-bit metadata words to be included in each Dolby E burst of the first one (“O1”) of the output bitstreams, and such sequence is delayed in delay stage 34 (for a time corresponding to the latency time of stage 31) and the output of stage 34 is asserted to signature generator 38 and formatter 41. Similarly, stage 32 is configured to generate a sequence of 4-bit metadata words to be included in each Dolby E burst of the second one (“O2”) of the output bitstreams, and such sequence is delayed in delay stage 35 (for a time corresponding to the latency time of stage 32) and the output of stage 35 is asserted to signature generator 39 and formatter 42, and stage 33 is configured to generate a sequence of 4-bit metadata words to be included in each Dolby E burst of the “N”th one of the output bitstreams, and such sequence is delayed in delay stage 36 (for a time corresponding to the latency time of stage 33) and the output of stage 36 is asserted to signature generator 40′ and formatter 50.

Signature generator 38 is configured to generate protection bits to be included in the supplementary data of the first one (“O1”) of the output bitstreams. It typically generates such protection bits as a result of performing HMAC/HASH computations. The protection bits (e.g., HASH bits) are included (by elements 40 and 41) in the supplementary data carried by bitstream O1, and are also included (by elements 42, 50 and each other 20-to-24 bit burst formatter coupled in parallel with formatters 41, 42, and 50) in the supplementary data of all the other output bitstreams.

Signature generator 39 is configured to generate protection bits to be included in the supplementary data of the second one (“O2”) of the output bitstreams. It typically generates such protection bits as a result of performing HMAC/HASH computations. The protection bits (e.g., HASH bits) are included (by elements 40 and 42) in the supplementary data carried by bitstream O2, and are also included (by elements 41, 50 and each other 20-to-24 bit burst formatter coupled in parallel with formatters 41, 42, and 50) in the supplementary data of all the other output bitstreams.

Signature generator 40′ is configured to generate protection bits to be included in the supplementary data of the “N”th one (“ON”) of the output bitstreams. It typically generates such protection bits as a result of performing HMAC/HASH computations. The protection bits (e.g., HASH bits) are included (by elements 40 and 50) in the supplementary data carried by bitstream ON, and are also included (by elements 41, 42 and each other 20-to-24 bit burst formatter coupled in parallel with formatters 41, 42, and 50) in the supplementary data of all the other output bitstreams.

Signature combining element 40 combines the protection bits from each of generators 38, 39, and 40′ (and from each other signature generator, for each of the third through “N−1”th one of the output bitstreams, which is coupled in parallel with generators 38, 39, and 40) into a combined protection bit stream. The combined protection bit stream is asserted from element 40 to each of 20-to-24 bit burst formatter elements 41, 42, and 50, and each other 20-to-24 bit burst formatter coupled in parallel with elements 41, 42, and 50.

The protection bits for each burst of each of the output bitstreams are utilized during the decode process (or in a post processing step following the decode process) to compare against an identical HMAC/HASH operation at the decoder taken over the same number of samples and supplementary data.

20-to-24 bit burst formatter element 41 is configured to combine the 20-bit primary audio from encoder 31, and the metadata from stage 34, and the combined protection bit stream from element 40, into a sequence of 24-bit output words. These output words are asserted to SMPTE 337 formatter 51, which is configured to generate output stream O1 in response thereto. Output stream O1 may have the format shown in FIG. 4, with metadata from stage 34 carried (in AES3 subframe locations) as supplementary data “S2” of FIG. 4, and protection bits from element 40 carried (in guard band locations) as supplementary data “S1” of FIG. 4.

Similarly, 20-to-24 bit burst formatter element 42 is configured to combine the 20-bit primary audio from encoder 32, and the metadata from stage 35, and the combined protection bit stream from element 40, into a sequence of 24-bit output words. These output words are asserted to SMPTE 337 formatter 52, which is configured to generate output stream O2 in response thereto. Output stream O2 may have the format shown in FIG. 4, with metadata from stage 35 carried (in AES3 subframe locations) as supplementary data “S2” of FIG. 4, and protection bits from element 40 carried (in guard band locations) as supplementary data “S1” of FIG. 4.

Similarly, 20-to-24 bit burst formatter element 50 is configured to combine the 20-bit primary audio from encoder 33, and the metadata from stage 36, and the combined protection bit stream from element 40, into a sequence of 24-bit output words. These output words are asserted to SMPTE 337 formatter 60, which is configured to generate output stream ON in response thereto. Output stream ON may have the format shown in FIG. 4, with metadata from stage 36 carried (in AES3 subframe locations) as supplementary data “S2” of FIG. 4, and protection bits from element 40 carried (in guard band locations) as supplementary data “S1” of FIG. 4.

Similarly, each other 20-to-24 bit burst formatter coupled in parallel with elements 41, 42, and 50 is configured to combine 20-bit primary audio data (indicative of a different set of audio channels), and corresponding metadata from stage 30, and the combined protection bit stream from element 40, into a sequence of 24-bit output words. These output words are asserted to a SMPTE 337 formatter (coupled in parallel with formatters 51, 52, and 60) configured to generate the corresponding one of output streams O3-O(N−1). Each of these output streams may have the format shown in FIG. 4, with metadata from stage 30 carried (in AES3 subframe locations) as supplementary data “S2” of FIG. 4, and protection bits from element 40 carried (in guard band locations) as supplementary data “S1” of FIG. 4.

The data of each of the output streams generated by the FIG. 7 system may be stored as a file rather than (or in addition to) being transmitted as a set of parallel bitstreams.

In a typical implementation of FIG. 7, each of the output serial bitstreams O1-ON comprises non-PCM primary audio data and non-PCM supplementary data, carried in bursts. In variations on such implementation, each of N generated output serial bitstreams (variations on streams O1-ON) comprises PCM (e.g., LPCM) primary audio data (e.g., data directly representing sample values of a “primary” audio signal) and PCM supplementary data in a sequence of AES3 frames (not organized into bursts). The latter bitstreams may also be transmitted (or the PCM data thereof may be stored as a file).

We next describe an embodiment of the inventive decoding system with reference to FIG. 8. In this exemplary embodiment, the decoding system receives (in parallel) a set of N encoded bitstreams (labeled in FIG. 8 as Input Bitstream 1, Input Bitstream 2, . . . , and Input Bitstream N) which have been generated in accordance with an embodiment of the invention. Each of the input bitstreams carries supplemental data and eight channels of primary audio data, with the supplemental data including protection bits, sync words (e.g., in a core element of a segment of metadata), and other metadata (e.g., processing state metadata indicative of one or more channels of the primary audio data).

SMPTE 337 deformatter 1 is coupled and configured to parse input bitstream 1, to assert the supplementary data thereof to deformatter 11, and to assert the primary audio data thereof to signature validator 15. Deformatter 11 is configured to parse the supplementary data, to assert the sync words thereof to stream offset compensation element 24, and to assert the protection bits thereof (and other bits of the supplementary data, including the metadata thereof) to signature validator 15.

SMPTE 337 deformatter 2 is coupled and configured to parse input bitstream 2, to assert the supplementary data thereof to deformatter 12, and to assert the primary audio data thereof to signature validator 16. Deformatter 12 is configured to parse the supplementary data, to assert the sync words thereof to stream offset compensation element 24, and to assert the protection bits thereof (and other bits of the supplementary data, including the metadata thereof) to signature validator 16.

Similarly, SMPTE 337 deformatter N is coupled and configured to parse input bitstream N, to assert the supplementary data thereof to deformatter 13, and to assert the primary audio data thereof to signature validator 17. Deformatter 13 is configured to parse the supplementary data, to assert the sync words thereof to stream offset compensation element 24, and to assert the protection bits thereof (and other bits of the supplementary data, including the metadata thereof) to signature validator 17.

Similarly, a SMPTE 337 deformatter (coupled in parallel with deformatters 1, 2, and N) is coupled and configured to parse each of the other input bitstreams N, to assert the supplementary data thereof to a supplementary data deformatter (coupled in parallel with deformatters 11, 12, and 13) and to assert the primary audio data thereof to a signature validator (coupled in parallel with validators 15, 16, and 17). Each supplementary data deformatter is configured to parse the supplementary data asserted thereto, to assert the sync words thereof to stream offset compensation element 24, and to assert the protection bits thereof (and other bits of the supplementary data, including the metadata thereof) to the corresponding signature validator.

Each signature validator (including each of elements 15, 16, and 17) is configured to use the protection bits (e.g., by performing an HMAC/HASH operation) to validate the primary audio data (and/or other supplementary data) which it receives. Signature validator 15 is coupled and configured to assert the validated primary audio data and corresponding metadata from input bitstream 1 to buffer 21, signature validator 16 is coupled and configured to assert the validated primary audio data and corresponding metadata from input bitstream 2 to buffer 22, signature validator 17 is configured to assert the validated primary audio data and corresponding metadata from input bitstream N to buffer 23, and each other signature validator is coupled and configured to assert the validated primary audio data and corresponding metadata from the corresponding input bitstream to a corresponding buffer (coupled in parallel with buffers 21, 21, and 23 in bitstream synchronization stage 18).

Bitstream synchronization stage 18 includes stream offset compensation element 24. Element 24 is coupled and configured to use the sync words of the supplementary data of each of the input bitstreams to determine any misalignment of data in the input bitstreams (e.g., which may occur due to the likelihood that tight synchronism among them is lost in distribution/contribution since each bitstream is typically carried over an independent AES3 real-time interface and/or track within a media file). Element 24 is also configured to correct any determined misalignment by asserting appropriate control values to the buffers (e.g., buffers 21, 22, and 23) containing the primary audio data and metadata of the input bitstreams, to cause time-aligned bits of the primary audio data to be read from the buffers to 20-bit Dolby E decoders (including decoders 25, 26, and 27), each of which is coupled to a corresponding one of the buffers, and to cause time-aligned bits of the metadata to be read from the buffers to metadata combining stage 19.

Time-aligned bits of the primary audio data (channels A1-A8) from the first input bitstream are read from buffer 21 to 20-bit Dolby E decoder 25, and time-aligned bits of the metadata (including metadata channels M1-M8) from the first input bitstream are read from buffer 21 to combiner 19. Decoder 25 is configured to perform Dolby E decoding on the primary audio data asserted thereto, and to assert the decoded audio of channels A1-A8 to rendering subsystem 20.

Time-aligned bits of the primary audio data (channels A9-A16) from the second input bitstream are read from buffer 22 to 20-bit Dolby E decoder 26, and time-aligned bits of the metadata (including metadata channels M9-M16) from the second input bitstream are read from buffer 22 to combiner 19. Decoder 26 is configured to perform Dolby E decoding on the primary audio data asserted thereto, and to assert the decoded audio of channels A9-A16 to rendering subsystem 20.

Time-aligned bits of the primary audio data (channels AX-A(X+7)) from the “N”th input bitstream are read from buffer 23 to 20-bit Dolby E decoder 27, and time-aligned bits of the metadata (including metadata channels MX-M(X+7)) from the “N”th input bitstream are read from buffer 23 to combiner 19. Decoder 27 is configured to perform Dolby E decoding on the primary audio data asserted thereto, and to assert the decoded audio of channels AX-A(X+7) to rendering subsystem 20.

Similarly, other 20-bit Dolby E decoders coupled in parallel with decoders 25, 26, and 27 are configured to decode the corresponding channels of time-aligned primary audio data from stage 18, and the corresponding channels of time-aligned metadata are asserted from stage 18 to combiner 19.

Metadata combiner 19 is configured to assert the time-aligned metadata for all the primary audio data channels in an appropriate format to rendering subsystem 20, and subsystem 20 is configured to use the metadata received from combiner 19 to render all N*8 channels of the decoded primary audio data.

It should be appreciated that some embodiments of the invention (e.g., some which send or receive a single “Dolby E” type bitstream) are backward compatible with a conventional decoder (e.g., a Dolby E decoder).

Some embodiments of the invention (e.g., some which send or receive multiple “Dolby E” type bitstreams) are not backward compatible with a conventional decoder (e.g., a Dolby E decoder). For example, the audio data and supplemental data included in each bitstream may be PCM data, and/or they may send or receive multiple bitstreams (each including audio and supplementary data) and require that a decoder parse synchronization words (included in the supplementary data) and use such synchronization words to synchronize the bitstreams with each other or with video data.

In some embodiments, the invention is a method for decoding an encoded audio bitstream, said method including steps of:

(a) receiving an encoded audio bitstream;

(b) extracting supplementary data and primary audio data from the encoded audio bitstream; and

(c) decoding the primary audio data, thereby generating decoded audio data,

wherein said encoded audio bitstream comprises a sequence of frames organized in a sequence of bursts, each of the bursts has a guard band segment and includes some of the frames, and wherein step (b) includes a step of extracting at least some of the supplementary data from at least one said guard band segment and extracting some of the primary audio data from each of at least a subset of the frames of each of the bursts.

In some such embodiments, each of the frames has N audio segments, each of the audio segments comprises M bits, and step (b) includes a step of identifying at least some of the supplementary data as the P least significant bits of each of at least some of the audio segments, and identifying some of the primary audio data as the M-P most significant bits of said each of at least some of the audio segments, where each of N, M, and P is a positive integer, and P is less than M.

In some such embodiments, the supplementary data includes processing state metadata indicative of the processing state of the primary audio data, and the method also includes a step of performing adaptive processing on the primary audio data extracted from the encoded audio bitstream using at least some of the processing state metadata.

In some embodiments, the invention is a method for decoding an encoded audio bitstream, said method including steps of:
(a) receiving an encoded audio bitstream;
(b) extracting supplementary data and primary audio data from the encoded audio bitstream; and
(c) decoding the primary audio data, thereby generating decoded audio data,
wherein the encoded audio bitstream comprises a sequence of frames, said encoded audio bitstream comprises a sequence of frames, each of the frames has N audio segments, each of the audio segments comprises M bits, at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M.

In some such embodiments, the supplementary data includes processing state metadata indicative of the processing state of the primary audio data, and the method includes a step of performing adaptive processing on the primary audio data extracted from the encoded audio bitstream using at least some of the processing state metadata.

In some embodiments, the invention provides low latency encoding and decoding of supplementary data (e.g., metadata) of an encoded audio bitstream (e.g., an encoded audio bitstream in Dolby E format) which includes the supplementary data and audio data in SMPTE 337 format. In these embodiments, supplementary data is included in at least two intervals (sometimes referred to below as segments) of at least one (and typically each) frame (sometimes referred to as a burst) of the bitstream. A first subset of the supplementary data is included in an interval (segment) of the frame, and a second subset of the supplementary data (sometimes referred to as additional supplementary data) is included in a later interval (segment) of the frame. The first subset of the supplementary data in the earlier segment includes supplementary data (sometimes referred to herein as “latency-reduction” supplementary data) corresponding to (e.g., regarding, or useful for parsing or for performing audio processing using) the additional supplementary data in the later segment. In some embodiments, the latency-reduction supplementary data is or includes loudness state processing metadata (LPSM), and the additional supplementary data also is or includes LPSM. Other aspects of the invention are encoding methods which generate an encoded audio bitstream which includes latency-reduction supplementary data and decoding methods which decode such a bitstream.

In an exemplary embodiment, the encoded audio bitstream has Dolby E format, metadata is included in the primary data segment of a frame of the bitstream, additional metadata (sometimes referred to herein as “guard band” metadata) is included in the final (guard band) segment of the frame, and optionally also additional metadata (sometimes referred to herein as “extension” metadata) is included in the extension data segment of the frame (between the primary data segment and the guard band). The metadata in the primary data segment includes metadata (“latency-reduction” metadata) useful for performing at least one step of audio processing (e.g., adaptive loudness processing) which also uses the guard band metadata in the guard band segment. Typically, the frame has N audio segments, each of the audio segments comprises M bits, the metadata in the primary data segment is included as the P least significant bits of each of at least some of the audio segments of the primary data segment (and any metadata in the extension data segment is included as the P least significant bits of each of at least some of the audio segments of the extension data segment), and primary audio data is included as the M-P most significant bits of said each of at least some of the audio segments (of the primary data segment, or both the primary data and extension data segments), where each of N, M, and P is a positive integer, and P is less than M.

In the example of the previous paragraph, if the guard band metadata and latency-reduction metadata together comprise a full set of loudness state processing metadata (LPSM) and the latency-reduction metadata were not included in the primary data segment (and were instead included in the guard band segment), a decoder would need to wait until nearly the entire frame (including the extension data segment and at least a portion of the guard band segment) is received before completing the decoding and parsing necessary to extract the full set of LPSM and perform adaptive loudness processing using the LPSM. In contrast, by including the latency-reduction metadata in the primary data segment (in accordance with an embodiment of the invention), the decoder can perform decoding and parsing on the primary data segment (without waiting for delivery of the guard band segment) to extract at least some of the LPSM and perform at least one step of the adaptive loudness processing using the LPSM extracted from the primary data segment.

In some embodiments, in order to support low latency decoding and encoding of metadata embedded within a Dolby E stream, the metadata is split into primary, extension, and guard band metadata segments. These segments directly correspond to (and are included in) the primary data, extension data, and guard band segments of a Dolby E frame. Each of the primary, extension, and guard band metadata segments may have a predetermined structure, including a header and optionally also at least one payload following the header. The primary metadata segment contains primary metadata which applies either to the entire frame, or to the primary segment of the frame only. The extension metadata segment contains metadata which applies only to the extension segment of the frame.

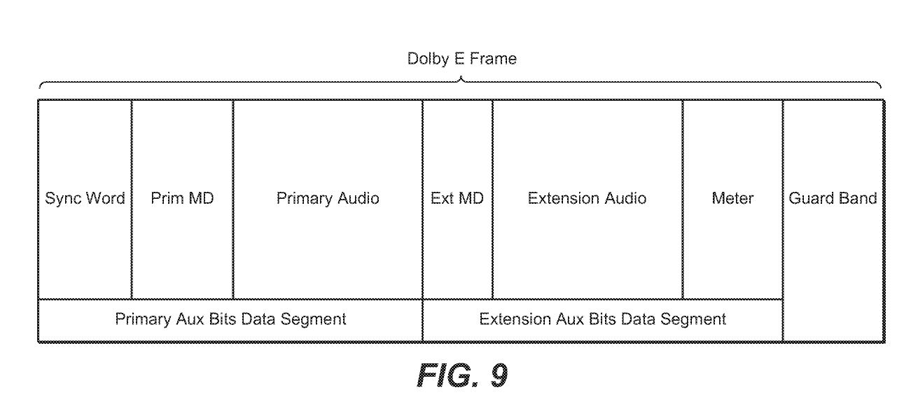

For example, FIG. 9 is a diagram of a frame (burst) of a Dolby E bitstream generated in accordance with an embodiment of the invention. The conventional Dolby E sync word (“Sync Word”) is included at the start of the frame's primary data segment. The primary data segment includes audio data (“primary audio”) and conventional Dolby E metadata (labeled “Prim MD” to indicate primary segment metadata) corresponding the primary audio, and a quantity of the inventive metadata (including latency-reduction metadata which is LPSM). The frame has N audio segments, each of the audio segments comprises M bits, and the inventive metadata in the primary data segment (labeled as “Primary Aux Bits Data Segment”) is included as the P least significant bits of each of at least some of the audio segments. The primary audio data and conventional (“Prim MD”) metadata are included as the M-P most significant bits of said each of at least some of the audio segments, where each of N, M, and P is a positive integer, and P is less than M.

The frame of FIG. 9 includes an extension data segment following the primary data segment, and a guard band following the extension data segment. The extension data segment includes audio data (“extension audio”), conventional Dolby E metadata (labeled “Ext MD” to indicate extension segment metadata) corresponding the extension audio, a conventional Dolby E meter segment (labeled “Meter”), and a quantity of the inventive metadata. The inventive metadata in the extension data segment (labeled as “Extension Aux Bits Data Segment”) is included as the P least significant bits of each of at least some of the audio segments of the extension data segment. The extension audio data, conventional (“Ext MD”) metadata, and meter segment bits are included as the M-P most significant bits of said each of at least some of the audio segments.

The guard band of the FIG. 9 frame also includes a quantity of the inventive metadata (including LPSM).

Still with reference to FIG. 9, the inventive metadata in the primary data segment (the “Primary Aux Bits Data Segment”) is aligned to the Dolby E sync word and does not extend beyond the final word (a CRC word) of the primary data segment. The inventive metadata in the extension data segment (the “Extension Aux Bits Data Segment”) is aligned to word 0 of the conventional metadata (“Ext MD”) of the extension data segment and does not extend beyond the final word (a CRC word) the meter segment.

In typical embodiments, low latency decoding and encoding of a full set of metadata (of which a portion is carried in an Dolby E frame's guard band) is supported by providing (as latency-reduction metadata) a subset of the fields of the full set of metadata within the primary metadata segment of the Dolby E frame. The remaining fields of the full set of metadata are provided in the guard band. For example, if the guard band metadata and latency-reduction metadata together comprise a full set of loudness state processing metadata (LPSM), the latency-reduction metadata may comprise LPSM payload identification and payload size values which identify the payload of the full set of metadata as being LPSM and indicate the payload's size, and loudness processing state values indicative of at least one type of loudness processing (e.g., dialog correction) performed on corresponding audio data.

In another class of embodiments, the inventive encoded audio bitstream includes a special code (referred to herein as an “escape code”) which is substituted for a word in a supplementary data segment (e.g., a metadata payload), where a conventional decoder (not configured to recognize the supplementary data) might otherwise mistake the word for a synchronization word (or other code word). Other aspects of the invention are encoding methods which generate such a bitstream and decoding methods which decode such a bitstream.

In an embodiment in this class, the encoded audio bitstream has Dolby E format, metadata is included in the guard band of at least one frame of the bitstream, and/or metadata is included as the P least significant bits (“auxiliary” or “aux” bits) of each of at least some audio segments (other than the guard band) of at least one frame of the bitstream. The metadata in the guard band (if present) is a metadata segment having a data structure including a header, and the metadata in the aux bits (if present) is also a metadata segment having the same data structure (including the header). The header includes the following sequence of three code words (and typically also includes additional code words after the three indicated code words):

a sync_word (indicating the start of the metadata segment);
escape_code_valid; and
escape_code.
The “sync_word” may be the value 0x5838.

The “escape_code” field specifies a 12-bit value (the “escape code”) that when found in the metadata segment (e.g., in a metadata payload following the header) is to be replaced (by the decoder) with a predetermined metadata value (e.g., the value 0x078, which comprises the first 12 bits of the conventional Dolby E sync word which appears at the start of a Dolby E frame). The encoder is configured in accordance with the invention to define the “escape_code” field by searching through the entire metadata segment (to be encoded into the bitstream) for an unused 12-bit value. This unused value is used as the escape code (the escape_code field) for the metadata segment of the current frame.

The encoder is also configured to search through the entire metadata segment (to be encoded into the bitstream) for each occurrence of the predetermined metadata value to be replaced (e.g., the value 0x078), and to replace each such value that is found with the escape code.

The decoder is configured to perform the inverse of these operations on each metadata segment (which has been parsed from the encoded bitstream delivered thereto), including by unpacking the 12-bit escape code (the “escape_code” value) from the header of the metadata segment, and searching for the escape code in the remaining portion of the metadata segment of the delivered bitstream. If the escape_code value is found, the decoder replaces it with the predetermined metadata value (e.g., the value 0x078). This functionality is implemented in order to prevent a bit sequence (e.g., one indicating the value 0x078) of the metadata segment that can be mistaken as a code word (e.g., the Dolby E sync word whose first twelve bits are 0x078), e.g., by a legacy decoder which is not configured to parse and the metadata segment from the encoded bitstream.

The “escape_code_valid” field in the header indicates whether a search for the escape_code (and a replacement of each occurrence thereof) is to be performed by the decoder. For example, if the “escape_code_valid” field has the value 1, this indicates that the escape_code should be unpacked and applied to the current frame, and if the “escape_code_valid” field has the value 0, this indicates that the escape_code value should be ignored (and that no search for the escape_code in the remaining portion of the metadata segment should be performed by the decoder). The 12-bits allocated for the escape_code are always present in the packed data.

In another class of embodiments, the inventive encoded audio bitstream includes a payload association code value (sometimes referred to herein as “codec_specific_id”) which identifies whether a single supplementary data payload (e.g., metadata payload) applies to one or more audio programs indicated by the encoded bitstream. Typically, each metadata segment of a frame of the bitstream includes a payload association code value for each metadata payload of the metadata segment, each payload association code value identifying each audio program indicated by the bitstream to which the payload applies. Other aspects of the invention are encoding methods which generate such a bitstream and decoding methods which decode such a bitstream (including by parsing the payload association code value(s)).

Each burst of a conventional Dolby E bitstream can include audio samples of up to 8 different audio programs, and includes auxiliary bits indicating to which program each sample belongs.

In an embodiment in this class, the inventive encoded audio bitstream has Dolby E format, and at least one frame of the bitstream includes at least one metadata segment having a data structure including a header and optionally at least one metadata payload following the header. The metadata segment may be included in the guard band of the frame, and/or in the P least significant bits (“auxiliary” or “aux” bits) of each of at least some audio segments (other than the guard band) of the frame. When multiple programs are present in the Dolby E bitstream, each metadata payload of a single metadata segment of a frame of the bitstream may be associated with one or more of the programs. The header of the metadata segment is indicative of the metadata segment's payload configuration, and includes a payload association code value for each metadata payload of the segment. Each payload association code value identifies each of the audio programs indicated by the encoded bitstream to which the payload applies.

For example, the bitstream frame of FIG. 9 may include samples of two programs, and the inventive metadata (labeled as “Primary Aux Bits Data Segment”) in the frame's primary data segment may be a metadata segment having a header followed by two metadata payloads. The payloads may comprise metadata of at least one type other than LPSM. The header may include a leading sync word followed by two payload association code values and typically also other code values. If the first one of the payloads applies to a first one of the programs (a “first program”) and the second one of the payloads applies to the other one of the programs (a “second program”), one payload association code value indicates that the first payload applies to the first program, and the other payload association code value indicates that the second payload applies to the second program. If the first one of the payloads applies to both the first program and the second program, and the second one of the payloads applies only to the second program, one payload association code value would indicate that the first payload applies to both the first program and the second program, and the other payload association code value would indicate that the second payload applies to the second program.

Similarly, the inventive metadata (labeled as “Extension Aux Bits Data Segment”) in the extension data segment (of the bitstream frame of FIG. 9) may be another metadata segment having a header followed by two metadata payloads. The header may include a leading sync word followed by two payload association code values and typically also other code values. If the first one of the metadata payloads of the extension data segment applies to the first program and the second one of the metadata payloads of the extension data segment applies to the second program, one payload association code value indicates that the first payload applies to the first program, and the other payload association code value indicates that the second payload applies to the second program. If the first one of the metadata payloads of the extension data segment applies to both the first program and the second program, and the second one of the metadata payloads of the extension data segment applies only to the second program, one payload association code value would indicate that the first payload applies to both the first program and the second program, and the other payload association code value would indicate that the second payload applies to the second program.

Similarly, the metadata of the guard band (of the bitstream frame of FIG. 9) may be another metadata segment having a header followed by two metadata payloads (e.g., two LPSM payloads). The header may include a leading sync word followed by two payload association code values and typically also other code values. If the first one of the payloads of the guard band applies to the first program and the second one of the payloads of the guard band applies to the second program, one payload association code value indicates that the first payload applies to the first program, and the other payload association code value indicates that the second payload applies to the second program. If the first one of the metadata payloads of the guard band applies to both the first program and the second program, and the second one of the metadata payloads of the guard band applies only to the second program, one payload association code value would indicate that the first payload applies to both the first program and the second program, and the other payload association code value would indicate that the second payload applies to the second program.

In some embodiments, each payload association code value is an 8-bit value, and each bit of this 8-bit value corresponds to a specific audio program indicated by samples of a frame of a Dolby E bitstream. Such a program consists of a set of PCM channels and corresponding Dolby Digital metadata. A Dolby E bitstream can be indicative of up to eight separate programs consisting of 1, 2, 4, 6 or 8 PCM channels;

A metadata segment of an example of the inventive bitstream (having Dolby E format) may have a header followed by at least one metadata payload. The header may include a leading sync word, followed by a flag indicating whether the header includes at least one payload association code value, followed by at least one payload association code value and typically also other code values. If each payload association code value is an 8-bit value, each bit of this 8-bit value corresponds to a specific audio program indicated by samples of a frame of the bitstream, and the metadata segment includes a metadata payload which applies to only one program, the corresponding bit in the payload association code value for the payload is set to a distinctive value (e.g., ‘1’). If each payload association code value is an 8-bit value, each bit of this 8-bit value corresponds to a specific audio program indicated by samples of a frame of the bitstream, and the metadata segment includes a metadata payload which applies to multiple programs, each corresponding bit in the payload association code value for the payload is set to the distinctive value (e.g., ‘1’).

In some embodiments, the invention is the following claim 1:

1. A method for generating an encoded audio bitstream, said method including steps of:

(a) providing primary audio data and supplementary data; and

(b) combining the primary audio data with at least some of the supplementary data to generate the encoded audio bitstream, such that said encoded audio bitstream comprises a sequence of frames, each of the frames has N audio segments, each of the audio segments comprises M bits, at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M.

Other embodiments are:

2. The method of claim 1, wherein each of the frames has the structure of an AES3 frame, and N=2, M=24, and P=4;

3. The method of claim 2, wherein the encoded audio bitstream is a Dolby E bitstream;

4. The method of claim 1, wherein the frames are organized in a sequence of bursts, each of the bursts has a guard band segment and includes some of the frames, and step (b) includes a step of including at least some of the supplementary data in at least one said guard band segment;

5. The method of claim 4, wherein the supplementary data includes at least one of additional audio content unrelated to the primary audio data, metadata associated with the primary audio data, synchronization words, protection bits, or metadata associated with the additional audio content;

6. The method of claim 4, wherein the supplementary data includes processing state metadata indicative of the processing state of the primary audio data;

7. The method of claim 4, wherein the primary audio data comprises at least one channel of audio content, and the supplementary data includes additional audio content comprising at least one additional audio channel;

8. The method of claim 7, wherein the at least one additional audio channel comprises at least one object channel;

9. The method of claim 4, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

10. The method of claim 9, wherein step (a) includes a step of encoding audio data, thereby generating the primary audio data;

11. The method of claim 4, wherein the primary audio data include audio data of at least one audio channel, and said method also includes a step of generating at least one additional encoded audio bitstream, including by:

(c) providing additional primary audio data, wherein the additional primary audio data include audio data of at least one additional audio channel; and

(d) combining the additional primary audio data with at least some of the supplementary data to generate the additional encoded audio bitstream, such that said additional encoded audio bitstream comprises a sequence of frames, each of the frames has N audio segments, where N is a positive integer, the frames are organized in a sequence of bursts, each of the bursts has a guard band segment and includes some of the frames, and step (d) includes a step of including at least some of the supplementary data in at least one said guard band segment;

12. The method of claim 11, wherein the supplemental data included in the encoded audio bitstream includes synchronization words, and the supplemental data included in the additional encoded audio bitstream includes additional synchronization words;

13. The method of claim 1, wherein the primary audio data and the supplemental data are pulse code modulated data;

14. The method of claim 1, wherein the supplementary data includes at least one of additional audio content unrelated to the primary audio data, metadata associated with the primary audio data, synchronization words, protection bits, or metadata associated with the additional audio content;

15. The method of claim 1, wherein the supplementary data includes processing state metadata indicative of the processing state of the primary audio data;

16. The method of claim 1, wherein the primary audio data comprises at least one channel of audio content, and the supplementary data includes additional audio content comprising at least one additional audio channel;

17. The method of claim 16, wherein the at least one additional audio channel comprises at least one object channel;

18. The method of claim 1, wherein the primary audio data include audio data of at least one audio channel, and said method also includes a step of generating at least one additional encoded audio bitstream, including by:

(c) providing additional primary audio data, wherein the additional primary audio data include audio data of at least one additional audio channel; and

(d) combining the additional primary audio data with at least some of the supplementary data to generate the additional encoded audio bitstream, such that said additional encoded audio bitstream comprises a sequence of frames, each of the frames has N audio segments, each of the audio segments comprises M bits, at least some of the supplementary data is included as the P least significant bits of each of at least some of the audio segments, and some of the additional primary audio data is included as the M-P most significant bits of said each of at least some of the audio segments, where each of N, M, and P is a positive integer, and P is less than M;

19. The method of claim 18, wherein the supplemental data included in the encoded audio bitstream includes synchronization words, and the supplemental data included in the additional encoded audio bitstream includes additional synchronization words;

20. The method of claim 1, wherein at least some of the supplementary data is included in at least two intervals of at least one burst of the encoded audio bitstream, a first subset of the supplementary data is included in an interval of the burst, a second subset of the supplementary data is included in a later interval of the burst, the first subset of the supplementary data includes supplementary data corresponding to the second subset of the supplementary data in the later interval;

21. The method of claim 20, wherein the supplementary data is or includes metadata useful for performing audio processing, and the first subset of the supplementary data is or includes metadata useful for performing at least one step of said audio processing;

22. The method of claim 1, wherein the supplementary data is or includes metadata, and step (b) includes a step of including, in the encoded audio bitstream, a metadata segment including an escape code and at least some of the metadata;

23. The method of claim 22, wherein the method includes steps of:

searching the metadata to be included in the metadata segment to identify an unused value which is not included in said metadata, and identifying the unused value as the escape code for the metadata segment; and

searching the metadata to be included in the metadata segment to identify a predetermined data value, replacing said metadata with modified metadata, wherein the modified metadata is identical to the metadata except in that each identified occurrence of the predetermined data value is replaced by the escape code, and including the modified metadata in the metadata segment; and

24. The method of claim 1, wherein each metadata segment of a burst of the encoded audio bitstream includes a payload association code value for each metadata payload of the metadata segment, each payload association code value identifying each audio program indicated by the bitstream to which the payload applies.

In some embodiments, the invention is the following claim 25:

25. A method for generating an encoded audio bitstream, said method including steps of:

(a) providing primary audio data and supplementary data; and

(b) combining the primary audio data with at least some of the supplementary data to generate the encoded audio bitstream, such that said encoded audio bitstream comprises a sequence of frames organized in a sequence of bursts, each of the bursts has a guard band segment and includes some of the frames, and wherein step (b) includes a step of including at least some of the supplementary data in at least one said guard band segment and including some of the primary audio data in each of at least a subset of the frames of each of the bursts.

Other embodiments are:

26. The method of claim 25, wherein each said guard band segment includes at least S sample locations, the first X of the sample locations include the supplementary data of the guard band segment, and each remaining one of the sample locations of the guard band segment includes a guard band symbol, where X is a number less than S;

27. The method of claim 25, wherein each of the frames has N audio segments, each of the audio segments comprises M bits, and step (b) includes a step of including at least some of the supplementary data as the P least significant bits of each of at least some of the audio segments, and including some of the primary audio data as the M-P most significant bits of said each of at least some of the audio segments, where each of N, M, and P is a positive integer, and P is less than M;

28. The method of claim 27, wherein each of the frames has the structure of an AES3 frame, and N=2, M=24, and P=4;

29. The method of claim 28, wherein the encoded audio bitstream is a Dolby E bitstream;

30. The method of claim 27, wherein the supplementary data includes at least one of additional audio content unrelated to the primary audio data, metadata associated with the primary audio data, synchronization words, protection bits, or metadata associated with the additional audio content;

31. The method of claim 27, wherein the supplementary data includes processing state metadata indicative of the processing state of the primary audio data;

32. The method of claim 27, wherein the primary audio data comprises at least one channel of audio content, and the supplementary data includes additional audio content comprising at least one additional audio channel;

33. The method of claim 32, wherein the at least one additional audio channel comprises at least one object channel;

34. The method of claim 25, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

35. The method of claim 34, wherein step (a) includes a step of encoding audio data, thereby generating the primary audio data;

36. The method of claim 25, wherein the supplementary data includes at least one of additional audio content unrelated to the primary audio data, metadata associated with the primary audio data, synchronization words, protection bits, or metadata associated with the additional audio content;

37. The method of claim 25, wherein the supplementary data includes processing state metadata indicative of the processing state of the primary audio data;

38. The method of claim 25, wherein the primary audio data comprises at least one channel of audio content, and the supplementary data includes additional audio content comprising at least one additional audio channel;

39. The method of claim 38, wherein the at least one additional audio channel comprises at least one object channel;

40. The method of claim 25, wherein the primary audio data include audio data of at least one audio channel, and said method also includes a step of generating at least one additional encoded audio bitstream, including by:

(c) providing additional primary audio data, wherein the additional primary audio data include audio data of at least one additional audio channel; and

(d) combining the additional primary audio data with at least some of the supplementary data to generate the additional encoded audio bitstream, such that said additional encoded audio bitstream comprises a sequence of frames, each of the frames has N audio segments, where N is a positive integer, the frames are organized in a sequence of bursts, each of the bursts has a guard band segment and includes some of the frames, and step (d) includes a step of including at least some of the supplementary data in at least one said guard band segment;

41. The method of claim 40, wherein the supplemental data included in the encoded audio bitstream includes synchronization words, and the supplemental data included in the additional encoded audio bitstream includes additional synchronization words;

42. The method of claim 25, wherein at least some of the supplementary data is included in at least two intervals of at least one burst of the encoded audio bitstream, a later one of the intervals is the guard band segment of the burst, a first subset of the supplementary data is included in an interval of the burst, a second subset of the supplementary data is included in guard band segment of the burst, the first subset of the supplementary data includes supplementary data corresponding to the second subset of the supplementary data in the guard band segment;

43. The method of claim 42, wherein the supplementary data is or includes metadata useful for performing audio processing, and the first subset of the supplementary data is or includes metadata useful for performing at least one step of said audio processing;

44. The method of claim 25, wherein the supplementary data is or includes metadata, and step (b) includes a step of including, in the encoded audio bitstream, a metadata segment including an escape code and at least some of the metadata;

45. The method of claim 44, wherein the method includes steps of:

searching the metadata to be included in the metadata segment to identify an unused value which is not included in said metadata, and identifying the unused value as the escape code for the metadata segment; and.

searching the metadata to be included in the metadata segment to identify a predetermined data value, replacing said metadata with modified metadata, wherein the modified metadata is identical to the metadata except in that each identified occurrence of the predetermined data value is replaced by the escape code, and including the modified metadata in the metadata segment; and

46. The method of claim 25, wherein each metadata segment of at least one of the bursts of the encoded audio bitstream includes a payload association code value for each metadata payload of the metadata segment, each payload association code value identifying each audio program indicated by the bitstream to which the payload applies.

In some embodiments, the invention is the following claim 47:

47. A method for decoding an encoded audio bitstream, said method including steps of:

(a) receiving an encoded audio bitstream;

(b) extracting supplementary data and primary audio data from the encoded audio bitstream; and

(c) decoding the primary audio data, thereby generating decoded audio data,

wherein the encoded audio bitstream comprises a sequence of frames, each of the frames has N audio segments, each of the audio segments comprises M bits, at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M.

Other embodiments are:

48. The method of claim 47, wherein each of the frames has the structure of an AES3 frame, and N=2, M=24, and P=4;

49. The method of claim 48, wherein the encoded audio bitstream is a Dolby E bitstream;

50. The method of claim 47, wherein the frames are organized in a sequence of bursts, each of the bursts has a guard band segment and includes some of the frames, and step (b) includes a step of extracting at least some of the supplementary data from at least one said guard band segment;

51. The method of claim 50, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

52. The method of claim 47, wherein the supplementary data includes at least one of additional audio content unrelated to the primary audio data, metadata associated with the primary audio data, synchronization words, protection bits, or metadata associated with the additional audio content;

53. The method of claim 47, wherein the supplementary data includes processing state metadata indicative of the processing state of the primary audio data, and wherein the method also includes a step of performing adaptive processing on the primary audio data extracted from the encoded audio bitstream using at least some of the processing state metadata;

54. The method of claim 47, wherein the primary audio data comprises at least one channel of audio content, and the supplementary data includes additional audio content comprising at least one additional audio channel;

55. The method of claim 54, wherein the at least one additional audio channel comprises at least one object channel;

56. The method of claim 47, wherein at least some of the supplementary data is included in at least two intervals of at least one burst of the encoded audio bitstream, a first subset of the supplementary data is included in an interval of the burst, a second subset of the supplementary data is included in a later interval of the burst, the first subset of the supplementary data includes supplementary data corresponding to the second subset of the supplementary data in the later interval;

57. The method of claim 56, wherein the supplementary data is or includes metadata useful for performing audio processing, and the first subset of the supplementary data is or includes metadata useful for performing at least one step of said audio processing;

58. The method of claim 47, wherein the supplementary data is or includes metadata, and step (b) includes a step of extracting, from the encoded audio bitstream, a metadata segment including an escape code and at least some of the metadata;

59. The method of claim 58, wherein the method includes a step of:

searching the metadata of the metadata segment to identify each occurrence of the escape code, and replacing each identified occurrence of the escape code with a predetermined metadata value; and

60. The method of claim 47, wherein each metadata segment of a burst of the encoded audio bitstream includes a payload association code value for each metadata payload of the metadata segment, each payload association code value identifying each audio program indicated by the bitstream to which the payload applies.

In some embodiments, the invention is the following claim 61:

61. A method for decoding an encoded audio bitstream, said method including steps of:

(a) receiving an encoded audio bitstream;

(b) extracting supplementary data and primary audio data from the encoded audio bitstream; and

(c) decoding the primary audio data, thereby generating decoded audio data,

wherein said encoded audio bitstream comprises a sequence of frames organized in a sequence of bursts, each of the bursts has a guard band segment and includes some of the frames, and wherein step (b) includes a step of extracting at least some of the supplementary data from at least one said guard band segment and extracting some of the primary audio data from each of at least a subset of the frames of each of the bursts.

Other embodiments are:

62. The method of claim 61, wherein each of the frames has N audio segments, each of the audio segments comprises M bits, and step (b) includes a step of identifying at least some of the supplementary data as the P least significant bits of each of at least some of the audio segments, and identifying some of the primary audio data as the M-P most significant bits of said each of at least some of the audio segments, where each of N, M, and P is a positive integer, and P is less than M;

63. The method of claim 62, wherein each of the frames has the structure of an AES3 frame, and N=2, M=24, and P=4;

64. The method of claim 61, wherein the encoded audio bitstream is a Dolby E bitstream;

65. The method of claim 61, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

66. The method of claim 61, wherein the supplementary data includes at least one of additional audio content unrelated to the primary audio data, metadata associated with the primary audio data, synchronization words, protection bits, or metadata associated with the additional audio content;

67. The method of claim 61, wherein the supplementary data includes processing state metadata indicative of the processing state of the primary audio data, and wherein the method also includes a step of performing adaptive processing on the primary audio data extracted from the encoded audio bitstream using at least some of the processing state metadata;

68. The method of claim 61, wherein the primary audio data comprises at least one channel of audio content, and the supplementary data includes additional audio content comprising at least one additional audio channel;

69. The method of claim 68, wherein the at least one additional audio channel comprises at least one object channel;

70. The method of claim 61, wherein at least some of the supplementary data is included in at least two intervals of at least one burst of the encoded audio bitstream, a first subset of the supplementary data is included in an interval of the burst, a second subset of the supplementary data is included in a later interval of the burst, the first subset of the supplementary data includes supplementary data corresponding to the second subset of the supplementary data in the later interval;

71. The method of claim 70, wherein the supplementary data is or includes metadata useful for performing audio processing, and the first subset of the supplementary data is or includes metadata useful for performing at least one step of said audio processing;

72. The method of claim 61, wherein the supplementary data is or includes metadata, and step (b) includes a step of extracting, from the encoded audio bitstream, a metadata segment including an escape code and at least some of the metadata;

73. The method of claim 72, wherein the method includes step of:

searching the metadata of the metadata segment to identify each occurrence of the escape code, and replacing each identified occurrence of the escape code with a predetermined metadata value; and

74. The method of claim 61, wherein each metadata segment of a burst of the encoded audio bitstream includes a payload association code value for each metadata payload of the metadata segment, each payload association code value identifying each audio program indicated by the bitstream to which the payload applies.

In some embodiments, the invention is the following claim 75:

75. A method for decoding encoded audio bitstreams, said method including steps of:

(a) receiving an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel;

(b) extracting the supplementary data, the primary audio data, and the additional primary audio data from the encoded audio bitstream and the additional encoded audio bitstream; and

(c) decoding the primary audio data, thereby generating decoded audio data of the at least one audio channel, and decoding the additional primary audio data, thereby generating additional decoded audio data of the at least one additional audio channel,

wherein each of the encoded audio bitstream and the additional encoded audio bitstream comprises a sequence of frames organized in a sequence of bursts, each of the bursts has a guard band segment and includes some of the frames, and wherein step (b) includes a step of extracting at least some of the supplementary data from at least one said guard band segment of the encoded audio bitstream, extracting at least some of the supplementary data from at least one said guard band segment of the additional encoded audio bitstream, extracting some of the primary audio data from each of at least a subset of the frames of each of the bursts of the encoded audio bitstream, and extracting some of the additional primary audio data from each of at least a subset of the frames of each of the bursts of the additional encoded audio bitstream.

Other embodiments are:

76. The method of claim 75, wherein the supplemental data extracted from the encoded audio bitstream includes synchronization words, the supplemental data extracted from the additional encoded audio bitstream includes additional synchronization words, and wherein said method also includes a step of:

using the synchronization words and the additional synchronization words to time align the primary audio data and the additional primary audio data, or the primary audio data, the additional primary audio data, and the supplementary data;

77. The method of claim 75, wherein the supplemental data extracted from the encoded audio bitstream includes synchronization words, the supplemental data extracted from the additional encoded audio bitstream includes additional synchronization words, and wherein said method also includes a step of:

using the synchronization words and the additional synchronization words to synchronize the primary audio data and the additional primary audio data with corresponding video frames, or to synchronize the primary audio data, the additional primary audio data, and the supplementary data with corresponding video frames; and

78. The method of claim 75, wherein each of the encoded audio bitstream and the additional encoded audio bitstream includes at least one synchronization word which is not included in the supplementary data, wherein said method also includes a step of:

using each said synchronization word to time align the primary audio data and the additional primary audio data.

In some embodiments, the invention is the following claim 79:

79. A method for decoding encoded audio bitstreams, said method including steps of:

(a) receiving an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel;

(b) extracting the supplementary data, the primary audio data, and the additional primary audio data from the encoded audio bitstream and the additional encoded audio bitstream; and

(c) decoding the primary audio data, thereby generating decoded audio data of the at least one audio channel, and decoding the additional primary audio data, thereby generating additional decoded audio data of the at least one additional audio channel,

wherein each of the encoded audio bitstream and the additional encoded audio bitstream comprises a sequence of frames, each of the frames has N audio segments, each of the audio segments comprises M bits, step (b) includes a step of extracting at least some of the supplementary data from the P least significant bit locations of each of at least some of the audio segments of the encoded audio bitstream, extracting at least some of the supplementary data from the P least significant bit locations of each of at least some of the audio segments of the additional encoded audio bitstream, extracting some of the primary audio data from the M-P most significant bit locations of said each of at least some of the audio segments of the encoded audio bitstream, and extracting some of the additional primary audio data from the M-P most significant bit locations of said each of at least some of the audio segments of the additional encoded audio bitstream, where each of N, M, and P is a positive integer, and P is less than M.

Other embodiments are:

80. The method of claim 79, wherein the supplemental data extracted from the encoded audio bitstream includes synchronization words, the supplemental data extracted from the additional encoded audio bitstream includes additional synchronization words, and wherein said method also includes a step of:

using the synchronization words and the additional synchronization words to time align the primary audio data and the additional primary audio data, or the primary audio data, the additional primary audio data, and the supplementary data;

81. The method of claim 79, wherein the supplemental data extracted from the encoded audio bitstream includes synchronization words, the supplemental data extracted from the additional encoded audio bitstream includes additional synchronization words, and wherein said method also includes a step of:

using the synchronization words and the additional synchronization words to synchronize the primary audio data and the additional primary audio data with corresponding video frames, or to synchronize the primary audio data, the additional primary audio data, and the supplementary data with corresponding video frames; and

82. The method of claim 79, wherein each of the encoded audio bitstream and the additional encoded audio bitstream includes at least one synchronization word which is not included in the supplementary data, wherein said method also includes a step of:

using each said synchronization word to time align the primary audio data and the additional primary audio data.

In some embodiments, the invention is the following claim 83:

83. An audio processing unit, including:

a buffer memory; and

at least one processing subsystem coupled to the buffer memory, wherein the buffer memory stores at least one segment of an encoded audio bitstream, said segment including supplementary data and primary audio data, wherein the processing subsystem is coupled and configured to perform at least one of generation of the bitstream, decoding of the bitstream, or adaptive processing of at least some of the primary audio data of the bitstream using at least some of the supplementary data of the bitstream, or at least one of authentication or validation of at least one of the primary audio data or supplementary data of the bitstream using at least some of the supplementary data of the bitstream,

wherein the encoded audio bitstream comprises a sequence of frames, each of the frames has N audio segments, each of the audio segments comprises M bits, at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M.

Other embodiments are:

84. The audio processing unit of claim 83, wherein each of the frames has the structure of an AES3 frame, and N=2, M=24, and P=4;

85. The audio processing unit of claim 84, wherein the encoded audio bitstream is a Dolby E bitstream;

86. The audio processing unit of claim 83, wherein the frames are organized in a sequence of bursts, each of the bursts has a guard band segment and includes some of the frames, and at least some of the supplementary data is included in at least one said guard band segment;

87. The audio processing unit of claim 83, wherein the supplementary data includes at least one of additional audio content unrelated to the primary audio data, metadata associated with the primary audio data, synchronization words, protection bits, or metadata associated with the additional audio content;

88. The audio processing unit of claim 83, wherein the supplementary data includes processing state metadata indicative of the processing state of the primary audio data;

89. The audio processing unit of claim 83, wherein the primary audio data comprises at least one channel of audio content, and the supplementary data includes additional audio content comprising at least one additional audio channel;

90. The audio processing unit of claim 89, wherein the at least one additional audio channel comprises at least one object channel;

91. The audio processing unit of claim 83, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

92. The audio processing unit of claim 83, wherein the buffer memory stores the frame in a non-transitory manner;

93. The audio processing unit of claim 83, wherein the audio processing unit is an encoder;

94. The audio processing unit of claim 83, wherein the audio processing unit is a decoder;

95. The audio processing unit of claim 83, wherein said audio processing unit is a digital signal processor;

96. The audio processing unit of claim 83, wherein at least some of the supplementary data is included in at least two intervals of at least one burst of the encoded audio bitstream, a first subset of the supplementary data is included in an interval of the burst, a second subset of the supplementary data is included in a later interval of the burst, the first subset of the supplementary data includes supplementary data corresponding to the second subset of the supplementary data in the later interval;

97. The audio processing unit of claim 96, wherein the supplementary data is or includes metadata useful for performing audio processing, and the first subset of the supplementary data is or includes metadata useful for performing at least one step of said audio processing;

98. The audio processing unit of claim 83, wherein the supplementary data is or includes metadata, and the processing subsystem is configured to include, in the encoded audio bitstream, a metadata segment including an escape code and at least some of the metadata;

99. The audio processing unit of claim 98, wherein the processing subsystem is configured to:

search the metadata to be included in the metadata segment to identify an unused value which is not included in said metadata, and identify the unused value as the escape code for the metadata segment; and.

search the metadata to be included in the metadata segment to identify a predetermined data value, replace said metadata with modified metadata, wherein the modified metadata is identical to the metadata except in that each identified occurrence of the predetermined data value is replaced by the escape code, and include the modified metadata in the metadata segment; and

100. The audio processing unit of claim 83, wherein each metadata segment of a burst of the encoded audio bitstream includes a payload association code value for each metadata payload of the metadata segment, each payload association code value identifying each audio program indicated by the bitstream to which the payload applies.

In some embodiments, the invention is the following claim 101:

101. An audio processing unit, including:

a buffer memory; and

at least one processing subsystem coupled to the buffer memory, wherein the buffer memory stores at least one segment of an encoded audio bitstream, said segment including supplementary data and primary audio data, wherein the processing subsystem is coupled and configured to perform at least one of generation of the bitstream, decoding of the bitstream, or adaptive processing of at least some of the primary audio data of the bitstream using at least some of the supplementary data of the bitstream, or at least one of authentication or validation of at least one of the primary audio data or supplementary data of the bitstream using at least some of the supplementary data of the bitstream,

wherein the encoded audio bitstream comprises a sequence of frames organized in a sequence of bursts, each of the bursts has a guard band segment and includes some of the frames, at least some of the supplementary data is included in at least one said guard band segment, and some of the primary audio data is included in each of at least a subset of the frames of each of the bursts.

Other embodiments are:

102. The audio processing unit of claim 101, wherein the encoded audio bitstream is a Dolby E bitstream;

103. The audio processing unit of claim 102, wherein the supplementary data includes at least one of additional audio content unrelated to the primary audio data, metadata associated with the primary audio data, synchronization words, protection bits, or metadata associated with the additional audio content;

104. The audio processing unit of claim 101, wherein the supplementary data includes processing state metadata indicative of the processing state of the primary audio data;

105. The audio processing unit of claim 101, wherein the primary audio data comprises at least one channel of audio content, and the supplementary data includes additional audio content comprising at least one additional audio channel;

106. The audio processing unit of claim 105, wherein the at least one additional audio channel comprises at least one object channel;

107. The audio processing unit of claim 101, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

108. The audio processing unit of claim 101, wherein the buffer memory stores the frame in a non-transitory manner;

109. The audio processing unit of claim 101, wherein the audio processing unit is an encoder;

110. The audio processing unit of claim 101, wherein the audio processing unit is a decoder;

111. The audio processing unit of claim 101, wherein said audio processing unit is a digital signal processor;

112. The audio processing unit of claim 101, wherein at least some of the supplementary data is included in at least two intervals of at least one burst of the encoded audio bitstream, a later one of the intervals is the guard band segment of the burst, a first subset of the supplementary data is included in an interval of the burst, a second subset of the supplementary data is included in guard band segment of the burst, the first subset of the supplementary data includes supplementary data corresponding to the second subset of the supplementary data in the guard band segment;

113. The audio processing unit of claim 112, wherein the supplementary data is or includes metadata useful for performing audio processing, and the first subset of the supplementary data is or includes metadata useful for performing at least one step of said audio processing;

114. The audio processing unit of claim 101, wherein the supplementary data is or includes metadata, and the processing subsystem is configured to include, in the encoded audio bitstream, a metadata segment including an escape code and at least some of the metadata;

115. The audio processing unit of claim 114, wherein the processing subsystem is configured to:

search the metadata to be included in the metadata segment to identify an unused value which is not included in said metadata, and identify the unused value as the escape code for the metadata segment; and

search the metadata to be included in the metadata segment to identify a predetermined data value, replace said metadata with modified metadata, wherein the modified metadata is identical to the metadata except in that each identified occurrence of the predetermined data value is replaced by the escape code, and include the modified metadata in the metadata segment; and

116. The audio processing unit of claim 101, wherein each metadata segment of at least one of the bursts of the encoded audio bitstream includes a payload association code value for each metadata payload of the metadata segment, each payload association code value identifying each audio program indicated by the bitstream to which the payload applies.

In some embodiments, the invention is the following claim 117:

117. An audio processing unit, including:

an encoding subsystem configured to encode audio data, thereby generating encoded primary audio data; and

a formatting subsystem coupled and configured to combine the primary audio data with supplementary data to generate an encoded audio bitstream, such that said encoded audio bitstream comprises a sequence of frames, each of the frames has N audio segments, each of the audio segments comprises M bits, at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M.

Other embodiments are:

118. The audio processing unit of claim 117, wherein each of the frames has the structure of an AES3 frame, and N=2, M=24, and P=4;

119. The audio processing unit of claim 117, wherein the encoded audio bitstream is a Dolby E bitstream;

120. The audio processing unit of claim 117, wherein the frames are organized in a sequence of bursts, each of the bursts has a guard band segment and includes some of the frames, and the formatting subsystem is configured to include at least some of the supplementary data in at least one said guard band segment;

121. The audio processing unit of claim 117, wherein the supplementary data includes at least one of additional audio content unrelated to the primary audio data, metadata associated with the primary audio data, synchronization words, protection bits, or metadata associated with the additional audio content;

122. The audio processing unit of claim 117, wherein the supplementary data includes processing state metadata indicative of the processing state of the primary audio data;

123. The audio processing unit of claim 117, wherein the primary audio data comprises at least one channel of audio content, and the supplementary data includes additional audio content comprising at least one additional audio channel; and

124. The audio processing unit of claim 117, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame.

In some embodiments, the invention is the following claim 125:

125. An audio processing unit, including:

an encoding subsystem configured to encode audio data, thereby generating encoded primary audio data; and

a formatting subsystem coupled and configured to combine the primary audio data with supplementary data to generate an encoded audio bitstream, such that said encoded audio bitstream comprises a sequence of frames organized in a sequence of bursts, each of the bursts has a guard band segment and includes some of the frames, at least some of the supplementary data is included in at least one said guard band segment, and some of the primary audio data is included in each of at least a subset of the frames of each of the bursts.

Other embodiments are:

126. The audio processing unit of claim 125, wherein the encoded audio bitstream is a Dolby E bitstream;

127. The audio processing unit of claim 125, wherein the supplementary data includes at least one of additional audio content unrelated to the primary audio data, metadata associated with the primary audio data, synchronization words, protection bits, or metadata associated with the additional audio content;

128. The audio processing unit of claim 125, wherein the supplementary data includes processing state metadata indicative of the processing state of the primary audio data;

129. The audio processing unit of claim 125, wherein the primary audio data comprises at least one channel of audio content, and the supplementary data includes additional audio content comprising at least one additional audio channel; and

130. The audio processing unit of claim 125, wherein the formatting subsystem is configured to generate an encoded audio bitstream such that each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame.

In some embodiments, the invention is the following claim 131:

131. An audio processing unit configured to decode an encoded audio bitstream indicative of supplementary data and primary audio data, said bitstream comprising a sequence of frames, each of the frames having N audio segments, each of the audio segments comprising M bits, wherein at least some of the supplementary data is included as the P least significant bits of each of at least some of the audio segments, and some of the primary audio data is included as the M-P most significant bits of said each of at least some of the audio segments, where each of N, M, and P is a positive integer, and P is less than M, said audio processing unit including:

a parsing subsystem coupled and configured to extract the supplementary data and the primary audio data from the encoded audio bitstream; and

a decoding subsystem coupled and configured to decode the primary audio data, thereby generating decoded primary audio data.

Other embodiments are:

132. The audio processing unit of claim 131, wherein each of the frames has the structure of an AES3 frame, and N=2, M=24, and P=4;

133. The audio processing unit of claim 131, wherein the encoded audio bitstream is a Dolby E bitstream;

134. The audio processing unit of claim 131, wherein the supplementary data includes at least one of additional audio content unrelated to the primary audio data, metadata associated with the primary audio data, synchronization words, protection bits, or metadata associated with the additional audio content;

135. The audio processing unit of claim 131, wherein the supplementary data includes processing state metadata indicative of the processing state of the primary audio data;

136. The audio processing unit of claim 131, wherein the primary audio data comprises at least one channel of audio content, and the supplementary data includes additional audio content comprising at least one additional audio channel;

137. The audio processing unit of claim 131, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

138. The audio processing unit of claim 131, wherein the supplementary data includes protection bits, said audio processing unit also including:

a validation stage, coupled to the parsing subsystem and configured to perform at least one of authentication or validation on at least one of the primary audio data or the supplementary data using the protection bits; and

139. The audio processing unit of claim 131, wherein said audio processing unit is a digital signal processor.

In some embodiments, the invention is the following claim 140:

140. An audio processing unit configured to decode an encoded audio bitstream indicative of supplementary data and primary audio data, said bitstream comprising a sequence of frames organized in a sequence of bursts, each of the bursts having a guard band segment and including some of the frames, said audio processing unit including:

a parsing subsystem coupled and configured to extract the supplementary data and the primary audio data from the encoded audio bitstream, including by extracting at least some of the supplementary data from at least one said guard band segment and extracting some of the primary audio data from each of at least a subset of the frames of each of the bursts; and

a decoding subsystem coupled and configured to decode the primary audio data, thereby generating decoded primary audio data.

Other embodiments are:

141. The audio processing unit of claim 140, wherein the encoded audio bitstream is a Dolby E bitstream;

142. The audio processing unit of claim 140, wherein the supplementary data includes at least one of additional audio content unrelated to the primary audio data, metadata associated with the primary audio data, synchronization words, protection bits, or metadata associated with the additional audio content;

143. The audio processing unit of claim 140, wherein the supplementary data includes processing state metadata indicative of the processing state of the primary audio data;

144. The audio processing unit of claim 140, wherein the primary audio data comprises at least one channel of audio content, and the supplementary data includes additional audio content comprising at least one additional audio channel;

145. The audio processing unit of claim 140, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame;

146. The audio processing unit of claim 140, wherein the supplementary data includes protection bits, said audio processing unit also including:

a validation stage, coupled to the parsing subsystem and configured to perform at least one of authentication or validation on at least one of the primary audio data or the supplementary data using the protection bits; and

147. The audio processing unit of claim 140, wherein said audio processing unit is a digital signal processor;

In some embodiments, the invention is the following claim 148:

148. An audio processing unit configured to decode an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel, wherein each of the encoded audio bitstream and the additional encoded audio bitstream comprises a sequence of frames organized in a sequence of bursts, each of the bursts having a guard band segment and including some of the frames, said audio processing unit including:

a parsing subsystem coupled and configured to extract at least some of the supplementary data from at least one said guard band segment of the encoded audio bitstream, to extract at least some of the supplementary data from at least one said guard band segment of the additional encoded audio bitstream, to extract some of the primary audio data from each of at least a subset of the frames of each of the bursts of the encoded audio bitstream, and to extract some of the additional primary audio data from each of at least a subset of the frames of each of the bursts of the additional encoded audio bitstream; and

a decoding subsystem coupled and configured to decode the primary audio data, thereby generating decoded audio data of the at least one audio channel, and to decode the additional primary audio data, thereby generating additional decoded audio data of the at least one additional audio channel,

Other embodiments are:

149. The audio processing unit of claim 148, wherein the supplemental data extracted from the encoded audio bitstream includes synchronization words, and the supplemental data extracted from the additional encoded audio bitstream includes additional synchronization words, said audio processing unit also including:

an alignment subsystem coupled and configured to use the synchronization words and the additional synchronization words to time align the primary audio data and the additional primary audio data, or the primary audio data, the additional primary audio data, and the supplementary data; and

150. The audio processing unit of claim 148, wherein the supplemental data extracted from the encoded audio bitstream includes synchronization words, and the supplemental data extracted from the additional encoded audio bitstream includes additional synchronization words, said audio processing unit also including:

an alignment subsystem coupled and configured to use the synchronization words and the additional synchronization words to synchronize the primary audio data and the additional primary audio data with corresponding video frames, or to synchronize the primary audio data, the additional primary audio data, and the supplementary data with corresponding video frames.

In some embodiments, the invention is the following claim 151:

151. An audio processing unit configured to decode an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel, wherein each of the encoded audio bitstream and the additional encoded audio bitstream comprises a sequence of frames, each of the frames has N audio segments, each of the audio segments comprises M bits, said audio processing unit including:

a parsing subsystem coupled and configured to extract at least some of the supplementary data from the P least significant bit locations of each of at least some of the audio segments of the encoded audio bitstream, to extract at least some of the supplementary data from the P least significant bit locations of each of at least some of the audio segments of the additional encoded audio bitstream, to extract some of the primary audio data from the M-P most significant bit locations of said each of at least some of the audio segments of the encoded audio bitstream, and to extract some of the additional primary audio data from the M-P most significant bit locations of said each of at least some of the audio segments of the additional encoded audio bitstream, where each of N, M, and P is a positive integer, and P is less than M; and

a decoding subsystem coupled and configured to decode the primary audio data, thereby generating decoded audio data of the at least one audio channel, and to decode the additional primary audio data, thereby generating additional decoded audio data of the at least one additional audio channel,

Other embodiments are:

152. The audio processing unit of claim 151, wherein the supplemental data extracted from the encoded audio bitstream includes synchronization words, and the supplemental data extracted from the additional encoded audio bitstream includes additional synchronization words, said audio processing unit also including:

an alignment subsystem coupled and configured to use the synchronization words and the additional synchronization words to time align the primary audio data and the additional primary audio data, or the primary audio data, the additional primary audio data, and the supplementary data; and

153. The audio processing unit of claim 151, wherein the supplemental data extracted from the encoded audio bitstream includes synchronization words, and the supplemental data extracted from the additional encoded audio bitstream includes additional synchronization words, said audio processing unit also including:

an alignment subsystem coupled and configured to use the synchronization words and the additional synchronization words to synchronize the primary audio data and the additional primary audio data with corresponding video frames, or to synchronize the primary audio data, the additional primary audio data, and the supplementary data with corresponding video frames.

Embodiments of the present invention may be implemented in hardware, firmware, or software, or a combination of both (e.g., as a programmable logic array). Unless otherwise specified, the algorithms or processes included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems (e.g., an implementation of any of the elements of FIG. 1, or encoder 100 of FIG. 2 (or an element thereof), or decoder 200 of FIG. 3 (or an element thereof), or post-processor 300 of FIG. 3 (or an element thereof)) each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

For example, when implemented by computer software instruction sequences, various functions and steps of embodiments of the invention may be implemented by multithreaded software instruction sequences running in suitable digital signal processing hardware, in which case the various devices, steps, and functions of the embodiments may correspond to portions of the software instructions.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be implemented as a computer-readable storage medium, configured with (i.e., storing) a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. Numerous modifications and variations of the present invention are possible in light of the above teachings. It is to be understood that within the scope of the appended claims, the invention may be practiced otherwise than as specifically described herein.

What is claimed is:

1. A method for generating an encoded audio bitstream, said method including steps of:
(a) providing primary audio data and supplementary data, wherein the primary audio data include audio data of at least one audio channel and the supplementary data include synchronization words and additional synchronization words; and
(b) combining the primary audio data with at least some of the supplementary data to generate the encoded audio bitstream, such that said encoded audio bitstream comprises a sequence of frames, the frames are organized in a sequence of bursts, each of the bursts has a guard band segment and includes some of the frames, each of the frames has N audio segments, each of the audio segments comprises M bits, wherein step (b) includes a step of including at least the synchronization words as the P least significant bits of each of at least some of the audio segments or a step of including at least the synchronization words in at least one said guard band segment, and some of the primary audio data is included as the M-P most significant bits of said each of at least some of the audio segments, where each of N, M, and P is a positive integer, and P is less than M, and
includes a step of generating at least one additional encoded audio bitstream, including by:
(c) providing additional primary audio data, wherein the additional primary audio data include audio data of at least one additional audio channel; and
(d) combining the additional primary audio data with at least some of the supplementary data to generate the additional encoded audio bitstream, such that said additional encoded audio bitstream comprises a sequence of frames, the frames are organized in a sequence of bursts, each of the bursts has a guard band segment and includes some of the frames, each of the frames has N audio segments, each of the audio segments comprises M bits, wherein step (d) includes a step of including at least the additional synchronization words in at least one said guard band segment of the additional encoded audio bitstream or a step of including at least the additional synchronization words as the P least significant bits of each of at least some of the audio segments of the additional encoded audio bitstream, and
wherein the synchronization words and the additional synchronization words are suitable for time aligning the primary audio data and the additional primary audio data, or the primary audio data, the additional primary audio data, and the supplementary data.

2. The method of claim 1, wherein each of the frames has the structure of an AES3 frame, and N=2, M=24, and P=4.

3. The method of claim 2, wherein the encoded audio bitstream is a Dolby E bitstream.

4. The method of claim 1, wherein the supplementary data includes at least one of additional audio content unrelated to the primary audio data, metadata associated with the primary audio data, synchronization words, protection bits, or metadata associated with the additional audio content.

5. The method of claim 1, wherein the supplementary data includes processing state metadata indicative of the processing state of the primary audio data.

6. The method of claim 1, wherein the primary audio data comprises at least one channel of audio content, and the supplementary data includes additional audio content comprising at least one additional audio channel.

7. The method of claim 6, wherein the at least one additional audio channel comprises at least one object channel.

8. The method of claim 3, wherein each of the bursts carries non-pulse-code modulated audio data in SMPTE 337 format, the non-pulse-code modulated audio data is or includes at least some of the primary audio data and at least some of the supplementary data, and each of the bursts corresponds to a time period equivalent to that of a corresponding video frame.

9. The method of claim 8, wherein step (a) includes a step of encoding audio data, thereby generating the primary audio data.

10. The method of claim 1, wherein the primary audio data and the supplementary data are pulse code modulated data.

11. The method of claim 1, wherein at least some of the supplementary data is included in at least two intervals of at least one burst of the encoded audio bitstream, a first subset of the supplementary data is included in an interval of the burst, a second subset of the supplementary data is included in a later interval of the burst, the first subset of the supplementary data includes supplementary data corresponding to the second subset of the supplementary data in the later interval.

12. The method of claim 11, wherein the supplementary data is or includes metadata useful for performing audio processing, and the first subset of the supplementary data is or includes metadata useful for performing at least one step of said audio processing.

13. The method of claim 1, wherein the supplementary data is or includes metadata, and step (b) includes a step of including, in the encoded audio bitstream, a metadata segment including an escape code and at least some of the metadata.

14. The method of claim 13, wherein the method includes steps of:
searching the metadata to be included in the metadata segment to identify an unused value which is not included in said metadata, and identifying the unused value as the escape code for the metadata segment; and
searching the metadata to be included in the metadata segment to identify a predetermined data value, replacing said metadata with modified metadata, wherein the modified metadata is identical to the metadata except in that each identified occurrence of the predetermined data value is replaced by the escape code, and including the modified metadata in the metadata segment.

15. The method of claim 1, wherein each metadata segment of a burst of the encoded audio bitstream includes a payload association code value for each metadata payload of the metadata segment, each payload association code value identifying each audio program indicated by the bitstream to which the payload applies.

16. A method for decoding encoded audio bitstreams, said method including steps of:
(a) receiving an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel;
(b) extracting the supplementary data, the primary audio data, and the additional primary audio data from the encoded audio bitstream and the additional encoded audio bitstream, wherein the supplementary data extracted from the encoded audio bitstream includes synchronization words, and wherein the supplementary data extracted from the additional encoded audio bitstream includes additional synchronization words;
(c) decoding the primary audio data, thereby generating decoded audio data of the at least one audio channel, and decoding the additional primary audio data, thereby generating additional decoded audio data of the at least one additional audio channel; and
(d) using the synchronization words and the additional synchronization words to time align the primary audio data and the additional primary audio data, or the primary audio data, the additional primary audio data, and the supplementary data,
wherein each of the encoded audio bitstream and the additional encoded audio bitstream comprises a sequence of frames organized in a sequence of bursts, each of the bursts has a guard band segment and includes some of the frames, each of the frames has N audio segments, each of the audio segments comprises M bits, and wherein step (b) includes a step of extracting the synchronization words from at least one said guard band segment of the encoded audio bitstream or of extracting the synchronization words from the P least significant bits of each of at least some of the audio segments, extracting the additional synchronization words from at least one said guard band segment of the additional encoded audio bitstream or of extracting the additional synchronization words from the P least significant bits of each of at least some of the audio segments, extracting some of the primary audio data from each of at least a subset of the frames of each of the bursts of the encoded audio bitstream, and extracting some of the additional primary audio data from each of at least a subset of the frames of each of the bursts of the additional encoded audio bitstream,
where each of N, M, and P is a positive integer, and P is less than M.

17. The method of claim 16, wherein said method also includes a step of:
using the synchronization words and the additional synchronization words to synchronize the primary audio data and the additional primary audio data with corresponding video frames, or to synchronize the primary audio data, the additional primary audio data, and the supplementary data with corresponding video frames.

18. The method of claim 16, wherein each of the encoded audio bitstream and the additional encoded audio bitstream includes at least one synchronization word which is not included in the supplementary data, wherein said method also includes a step of:
using each said synchronization word to time align the primary audio data and the additional primary audio data.

19. The method of claim 16, wherein each of the frames has the structure of an AES3 frame, and N=2, M=24, and P=4.

20. The method of claim 16, wherein the encoded audio bitstream is a Dolby E bitstream.

21. An audio processing unit for generating an encoded audio bitstream and at least one additional encoded audio bitstream, the audio processing unit comprising one or more processors configured to:
(a) provide primary audio data and supplementary data, wherein the primary audio data include audio data of at least one audio channel and the supplementary data include synchronization words and additional synchronization words;
(b) combine the primary audio data with at least some of the supplementary data to generate the encoded audio bitstream, such that said encoded audio bitstream comprises a sequence of frames, the frames are organized in a sequence of bursts, each of the bursts has a guard band segment and includes some of the frames, each of the frames has N audio segments, each of the audio segments comprises M bits, wherein step (b) includes a step of including at least the synchronization words as the P least significant bits of each of at least some of the audio segments or a step of including at least the synchronization words in at least one said guard band segment, and some of the primary audio data is included as the M-P most significant bits of said each of at least some of the audio segments, where each of N, M, and P is a positive integer, and P is less than M;
(c) provide additional primary audio data, wherein the additional primary audio data include audio data of at least one additional audio channel; and
(d) combine the additional primary audio data with at least some of the supplementary data to generate the additional encoded audio bitstream, such that said additional encoded audio bitstream comprises a sequence of frames, the frames are organized in a sequence of bursts, each of the bursts has a guard band segment and includes some of the frames, each of the frames has N audio segments, each of the audio segments comprises M bits, wherein step (d) includes a step of including at least the additional synchronization words in at least one said guard band segment of the additional encoded audio bitstream or a step of including at least the additional synchronization words as the P least significant bits of each of at least some of the audio segments of the additional encoded audio bitstream, and
wherein the synchronization words and the additional synchronization words are suitable for time aligning the primary audio data and the additional primary audio data, or the primary audio data, the additional primary audio data, and the supplementary data.

22. An audio processing unit for decoding encoded audio bitstreams, the audio processing unit comprising one or more processors configured to:
(a) receive an encoded audio bitstream and at least one additional encoded audio bitstream, wherein the encoded audio bitstream is indicative of primary audio data and supplementary data, the additional encoded audio bitstream is indicative of additional primary audio data and supplementary data, the primary audio data include audio data of at least one audio channel, and the additional primary audio data include audio data of at least one additional audio channel;
(b) extract the supplementary data, the primary audio data, and the additional primary audio data from the encoded audio bitstream and the additional encoded audio bitstream, wherein the supplementary data extracted from the encoded audio bitstream includes synchronization words, and wherein the supplementary data extracted from the additional encoded audio bitstream includes additional synchronization words;
(c) decode the primary audio data, thereby generating decoded audio data of the at least one audio channel, and decoding the additional primary audio data, thereby generating additional decoded audio data of the at least one additional audio channel; and
(d) use the synchronization words and the additional synchronization words to time align the primary audio data and the additional primary audio data, or the primary audio data, the additional primary audio data, and the supplementary data,
wherein each of the encoded audio bitstream and the additional encoded audio bitstream comprises a sequence of frames organized in a sequence of bursts, each of the bursts has a guard band segment and includes some of the frames, each of the frames has N audio segments, each of the audio segments comprises M bits, and wherein step (b) includes a step of extracting the synchronization words from at least one said guard band segment of the encoded audio bitstream or of extracting the synchronization words from the P least significant bits of each of at least some of the audio segments, extracting the additional synchronization words from at least one said guard band segment of the additional encoded audio bitstream or of extracting the additional synchronization words from the P least significant bits of each of at least some of the audio segments, extracting some of the primary audio data from each of at least a subset of the frames of each of the bursts of the encoded audio bitstream, and extracting some of the additional primary audio data from each of at least a subset of the frames of each of the bursts of the additional encoded audio bitstream, where each of N, M, and P is a positive integer, and P is less than M.
